(19) United States
(12) Patent Application Publication
(10) Pub. No.: US 2020/0109239 A1
(43) Pub. Date: Apr. 9, 2020

(54) CARBON DIOXIDE MEDIATED ANIONIC RING OPENING POLYMERIZATION OF CYCLIC ESTERS

(71) Applicant: King Abdullah University of Science and Technology, Thuwal (SA)

(72) Inventors: Xiaoshuang FENG, Thuwal (SA); Jobi VARGHESE, Thuwal (SA); Yves GNANOU, Thuwal (SA); GNANOU HADJICHRISTIDIS, Thuwal (SA)

(21) Appl. No.: 16/470,394

(22) PCT Filed: Dec. 14, 2017
(86) PCT No.: PCT/IB2017/057961

§ 371 Date: Jun. 17, 2019

Related U.S. Application Data
(60) Provisional application No. 62/434,924, filed on Dec. 15, 2016.

(51) Int. Cl. C08G 63/08; C08K 3/20

(52) U.S. Cl. CPC C08G 63/08; C08K 5/057; C08K 3/20

(57) ABSTRACT

Embodiments of the present disclosure describe a method of making a polyester compound comprising adding an initiator to a reaction medium, charging the reaction medium with an amount of carbon dioxide, and adding a cyclic ester compound to the reaction medium.

### BACKGROUND

Aliphatic polyesters are of great interest for many applications ranging from microelectronics, adhesives, and packaging to biomedical devices and pharmaceuticals. The main synthetic methods are based on the ring-opening polymerization of cyclic esters, which include anionic, cationic, coordination, organocatalytic and enzymatic polymerizations. At present, coordination polymerizations based on tin and aluminum are the most utilized for their ease of synthesis of polyesters with controlled molar mass and narrow molar mass distribution. However, the presence of metal residues after polymerization is an issue, as the latter have to be removed from the polyester formed-in particular for biomedical applications. A great deal of effort has thus been devoted to polymerize lactones by resorting to less toxic metals, such as main group alkali and alkaline-earth metals or to organic cations. Alkali metal alkoxides bring about the polymerization of cyclic esters, but both propagation and side reactions namely inter- and intra-transesterification reactions are known to occur simultaneously in the presence of such strongly basic alkoxides (Scheme 1—Prior Art). Scheme 1 provides examples of reactions occurring in conventional anionic ring opening polymerization of cyclic esters.

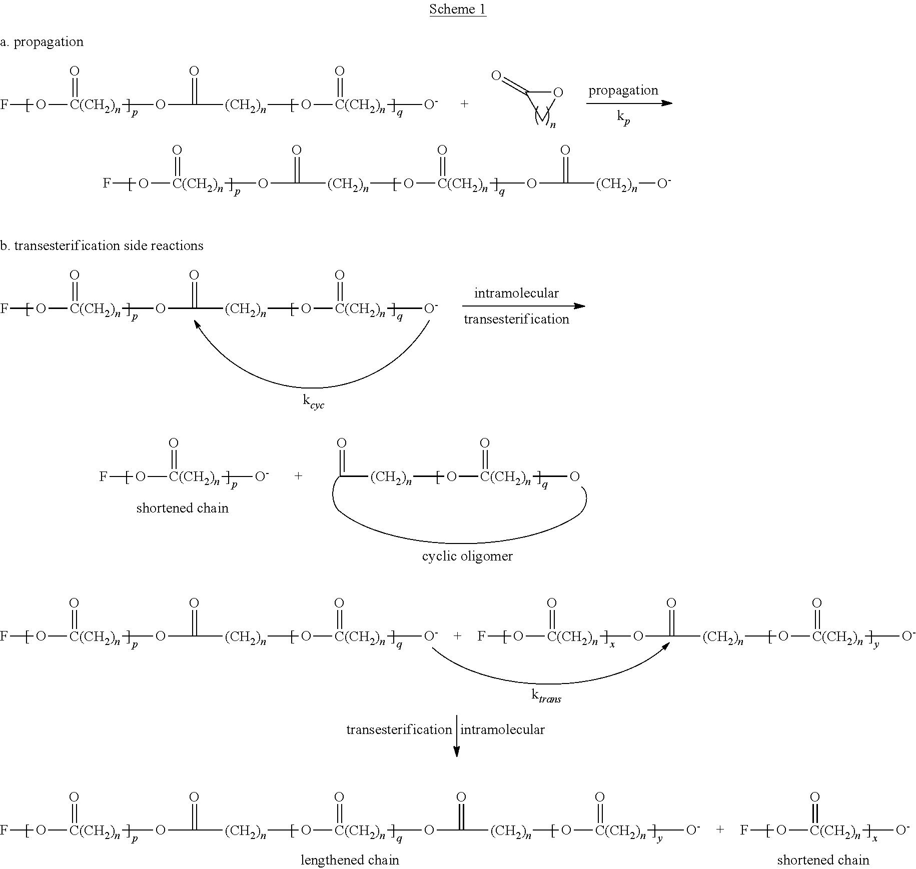

The consequence of the occurrence of such transesterification reactions is the broadening of the molar mass distribution. To avoid, if not totally, at least partially these transesterifications, scrambling reactions, one strategy was to activate selectively the lactone monomer to favor propagation over the side reactions. Using a bulky bis(2,6-di-t-butylphenoxy) ethylaluminum Lewis acid to activate ε-caprolactone, scientists succeeded to anionically polymerize ε-caprolactone under controlled/living conditions with tert-butyllithium as initiator. Recently, Waymouth resorted to the same strategy to activate the carbonyl function, both lactones and lactides and dithioureas were used for this purpose: it was also claimed that propagation is favored by this method and that a controlled polymerization of cyclic esters could be achieved.

Another strategy was to engineer around these alkali and alkali earth metals alkoxides bulky and complex ligands with the view of suppressing transesterification side reactions. In this case, the activity of propagating species was reduced but transesterification was less likely to occur: the proponents of this strategy pioneered the use of lithium complexes bearing bulky phenolate ligands and showed the livingness of L-lactide polymerization under these conditions. Even without considering their toxicity and availability, the multistep synthesis of such ligands is a major limitation.

### SUMMARY

In general, embodiments of the present disclosure describe the use of carbon dioxide in producing polyesters with a low polydispersity index.

Accordingly, embodiments of the present disclosure describe a method of making a polyester compound comprising adding an initiator to a reaction medium, charging the reaction medium with an amount of carbon dioxide, and adding a cyclic ester compound to the reaction medium.

Embodiments of the present disclosure further describe a method of making a polyester compound comprising adding an initiator to a reaction medium, wherein the initator is an alkali alkoxide, charging the reaction medium with an amount of carbon dioxide sufficient to suppress transesterification reactions, and adding a cyclic ester compound to the reaction medium.

The details of one or more examples are set forth in the description below. Other features, objects, and advantage will be apparent from the description and from the claims.

### BRIEF DESCRIPTION OF DRAWINGS

This written disclosure describes illustrative embodiments that are non-limiting and non-exhaustive. In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

Reference is made to illustrative embodiments that are depicted in the figures, in which:

FIG. 1 is a flowchart of a method of making a polyester compound, according to one or more embodiments of the present disclosure.

FIG. 2 is a graphical view of polycaprolactone (Entry 3) characterized by MALDI-ToF, according to one or more embodiments of the present disclosure.

FIG. 3 is a graphical view of polycaprolactone (Entry 3) characterized by GPC, according to one or more embodiments of the presnt disclosure.

FIG. 4 is a graphical view of polycaprolactone (Entry 3) characterized by NMR, according to one or more embodiments of the present disclosure.

FIG. 5 is a graphical view of polycaprolactone (Entry 4) characterized by GPC, according to one or more embodiments of the present disclosure.

FIG. 6 is a graphical view of polycaprolactone (Entry 4) characterized by NMR, according to one or more embodiments of the present disclosure.

FIG. 7 is a graphical view of polycaprolactone (Entry 8) characterized by GPC, according to one or more embodiments of the present disclosure.

FIG. 8 is a graphical view of polycaprolactone (Entry 8) characterized by NMR, according to one or more embodiments of the present disclosure.

FIG. 9 is a graphical view of polycaprolactone (Entry 5) characterized by GPC, according to one or more embodiments of the present disclosure.

FIG. 10 is a graphical view of polycaprolactone (Entry 5) characterized by NMR, according to one or more embodiments of the present disclosure.

FIG. 11 is a graphical view of polycaprolactone (Entry 6) characterized by GPC, according to one or more embodiments of the present disclosure.

FIG. 12 is a graphical view of polycaprolactone (Entry 6) characterized by NMR, according to one or more embodiments of the present disclosure.

FIG. 13 is a graphical view of polycaprolactone (Entry 12) characterized by GPC, according to one or more embodiments of the present disclosure.

FIG. 14 is a graphical view of polycaprolactone (Entry 12) characterized by NMR, according to one or more embodiments of the present disclosure.

FIG. 15 is a graphical view of polycaprolactone (Entry 11) characterized by GPC, according to one or more embodiments of the present disclosure.

FIG. 16 is a graphical view of polycaprolactone (Entry 11) characterized by NMR, according to one or more embodiments of the present disclosure.

FIG. 17 is a graphical view of polycaprolactone (Entry 14) characterized by GPC, according to one or more embodiments of the present disclosure.

FIG. 18 is a graphical view of polycaprolactone (Entry 14) characterized by NMR, according to one or more embodiments of the present disclosure.

FIG. 19 is a graphical view of polycaprolactone (Entry 15) characterized by GPC, according to one or more embodiments of the present disclosure.

FIG. 20 is a graphical view of polycaprolactone (Entry 15) characterized by NMR, according to one or more embodiments of the present disclosure.

FIG. 21 is a graphical view of polycaprolactone (Entry 19) characterized by GPC, according to one or more embodiments of the present disclosure.

FIG. 22 is a graphical view of polylactide (Entry 26) characterized by GPC, according to one or more embodiments of the present disclosure.

FIG. 23 is a graphical view of polylactide (Entry 26) characterized by NMR, according to one or more embodiments of the present disclosure.

FIG. 24 is a graphical view of polypropiolactone (Entry 27) characterized by GPC, according to one or more embodiments of the present disclosure.

FIG. 25 is a graphical view of polypropiolactone (Entry 27) characterized by NMR, according to one or more embodiments of the present disclosure.

FIG. 26 is a graphical view of polylactide (Entry 22) characterized by NMR, according to one or more embodiments of the present disclosure.

FIG. 27 is a graphical view of polylactide (Entry 22) characterized by MALDI-ToF, according to one or more embodiments of the present disclosure.

FIG. 28 is a graphical view of poly(ε-caprolactone) prepared in DCM in the absence and presence of CO₂ (Entry 1, 3-6), according to one or more embodiments of the present disclosure.

FIGS. 29A-29F are representative MALDI-ToF characterization results of poly(ε-caprolactone) initiated by MEEOLi—or other initiators otherwise mentioned—and prepared in different conditions with a targeted DP of 50: (A) blank in CH₂Cl₂ (no CO₂ added, entry 1); (B) 1.5 eq. of CO₂ in CH₂Cl₂ (entry 3 in Table 1); (C) initiated only by MEEOCO₂Li in CH₂Cl₂ (entry 17 in Table 1); (D) initiated by MEEOCO₂Li and in the presence of 0.5 eq. of CO₂ in CH₂Cl₂ (entry 18 in Table 1); (E) 1.5 eq. of CO₂ in THF (entry 9 in Table 1); (F) 1.5 eq. of CO₂ in toluene (entry 13 in Table 1), according to one or more embodiments of the present disclosure.

FIG. 30 is a representative ¹H NMR spectrum of poly(ε-caprolactone) (entry 3, Table 1), according to one or more embodiments of the present disclosure.

FIGS. 31A-31D are MALDI-ToF characterization results of PLLA prepared at different temperature (DP targeted equal to 100, 3 eq. CO₂, initiated by MEEOLi, entry 22-25, Table 1). (A): 50° C.; (B): 20° C.; (C): −20° C.; (D); −20° C., no CO₂, according to one or more embodiments of the present disclosure.

FIG. 32 is a ¹H NMR spectrum of LLA (entry 24, Table 1), according to one or more embodiments of the present disclosure.

FIGS. 33A-33B are Pulse-Field-Gradient NMR characterization results of MEEOH (0.08 mmol) and lithium carbonate MEEOCO₂Li (0.08 mmol) in CD₂Cl₂ at room temperature (the ratio of two values is 4.3, suggesting tetrameric structure of lithium carbonate), according to one or more embodiments of the present disclosure.

FIG. 34, which is also referred to as Scheme 2, is a free energy reaction profile for the proposed lithium carbonate tetramer with ε-caprolactone (CL) and ethyl acetate (EA) in the presence of CO₂, according to one or more embodiments of the present disclosure.

FIG. 35 is calculation results of energy for the formation of dimers, trimers, and tetramers from CO₂ and MeOLi, according to one or more embodiments of the present disclosure.

FIGS. 36A-36B are isotopic exchange 13C NMR experiment results of lithium carbonate of DGEM in CD₂Cl₂ under same acquisition conditions: (A) original carbonate sample (B) characterization after heating in the atmosphere (1 bar) of ¹³CO₂ at 70° C. for two hours, according to one or more embodiments of the present disclosure.

### DETAILED DESCRIPTION

Embodiments of the present disclosure describe the use of carbon dioxide in producing polyesters with a low polydispersity index. Some embodiments utilize alkali metals, such as lithium, as part of the chelating bond as opposed to aluminum, titanium, and tin. In addition, introducing carbon dioxide in very minute amounts results in hindering side polymerization reactions and eventually produces polymers with low polydispersity index. Such resultant polymers can be used in specialty applications, such as medical devices, as they do not have toxic residual heavy metals, only lithium residue.

Carbon dioxide is an abundant, inexpensive, and non-toxic renewable C1 resource that is considered for the production of value-added chemicals and materials, such as urea, carbonates, methanol, salicylic acid, and polycarbonates, etc. On the other hand, CO₂ has also been used to reversibly trap certain species and switch the properties of the latter from polar to nonpolar, hydrophobic to hydrophilic, and dormant to active species. The switch from dormant to active species and vice-versa was applied to reversibly stop and resume polymerization of cyclic esters. Upon heating, carbene-CO₂ adducts used as precatalyst released the carbene as initiator for ring opening polymerization of cyclic esters. In the case of cyclic esters, it was reported the “regulation” of their polymerization of cyclic esters by several “on/off” cycles, alternating the flow of CO₂ and nitrogen. More recently, scientists reported the synthesis of well-defined polycarbonate and polyester block copolymers in one pot through sequential selective polymerization of epoxides and CO₂, and lactones. These results demonstrated that in the presence of CO₂ alkoxides are inactive for the ring opening polymerization of cyclic esters due to the formation of carbonates but can further serve again for the ROP of cyclic esters after removal of CO₂.

Embodiments herein unveil a totally novel strategy based on the use of carbon dioxide (CO₂) along with the use alkali alkoxides as a means to bring about the controlled/living polymerization of lactones and thus, if not totally suppress, at least dramatically decrease the occurrence of transesterification reactions. In the current embodiments, it is demonstrated that upon adding a precise amount of CO₂—typically between 1 and 10 times the amount of growing alkoxides—to tune the activity of alkali alkoxides, the polymerization of cyclic esters is not shut down as described by others, but proceeds under living conditions without detectable transesterification reactions. To suppress transesterifications during polymerization, the embodiments described herein charge a certain amount of CO₂ into the reaction medium. Under such conditions, a fast equilibrium between carbonate (dormant) and alkoxide (active) species takes place allowing at certain temperature, under vacuum or nitrogen atmosphere all polyester chains to grow in a living/controlled manner. In the presence of CO₂ the vast majority of active alkoxides are thus transformed into dormant carbonates, but a minute amount of alkali alkoxides remains that is responsible for the ROP of cyclic esters. It is important to point out that this minute amount of active alkoxides does not indulge in side transesterification reactions unlike “naked” alkoxides, as if a new active species less reactive than “naked” alkoxides were formed.

Scheme 2 provided below is an example of a reaction scheme of carbon dioxide mediated anionic ring opening polymerization of cyclic esters:

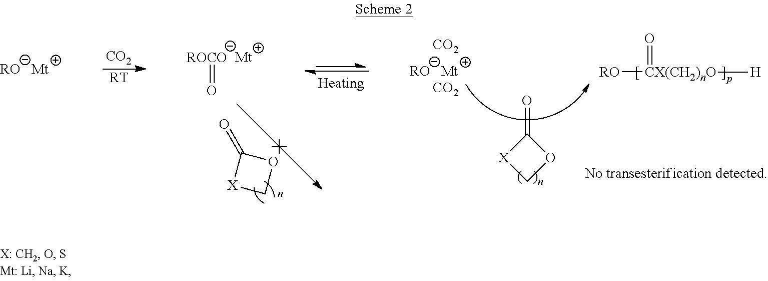

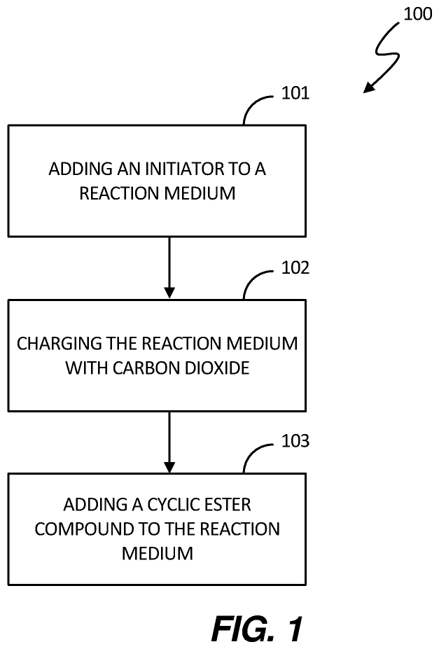

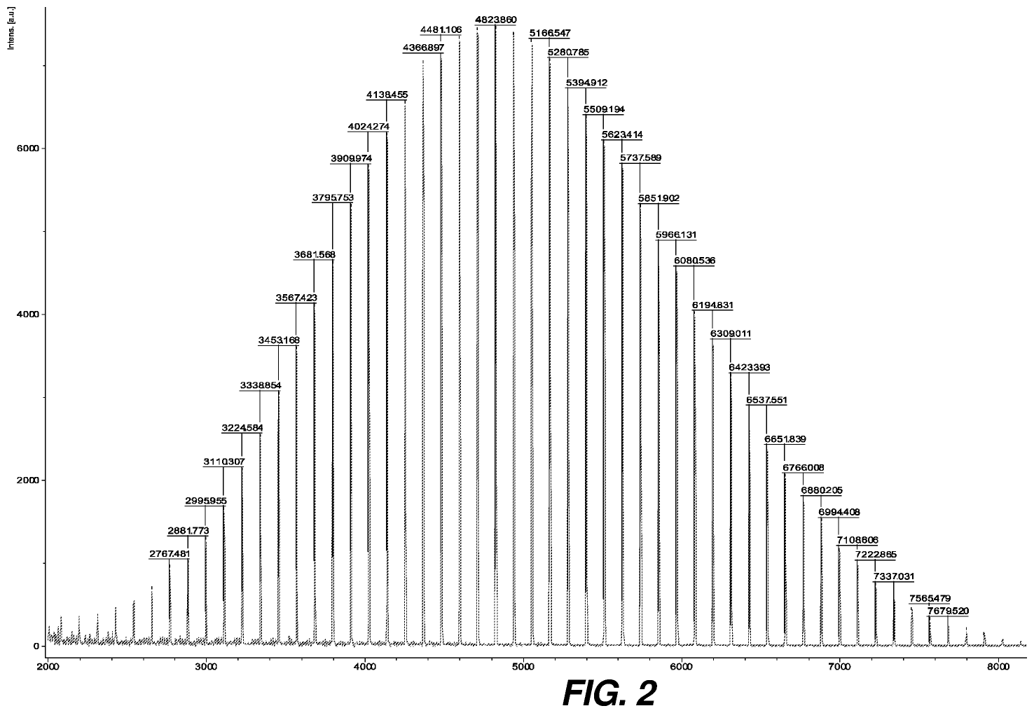

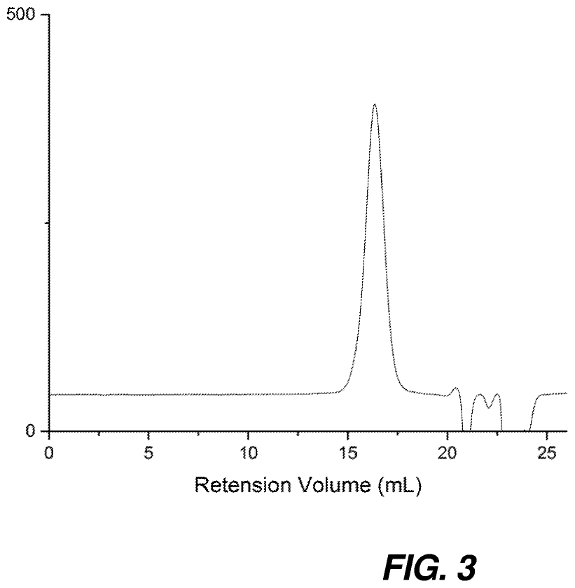

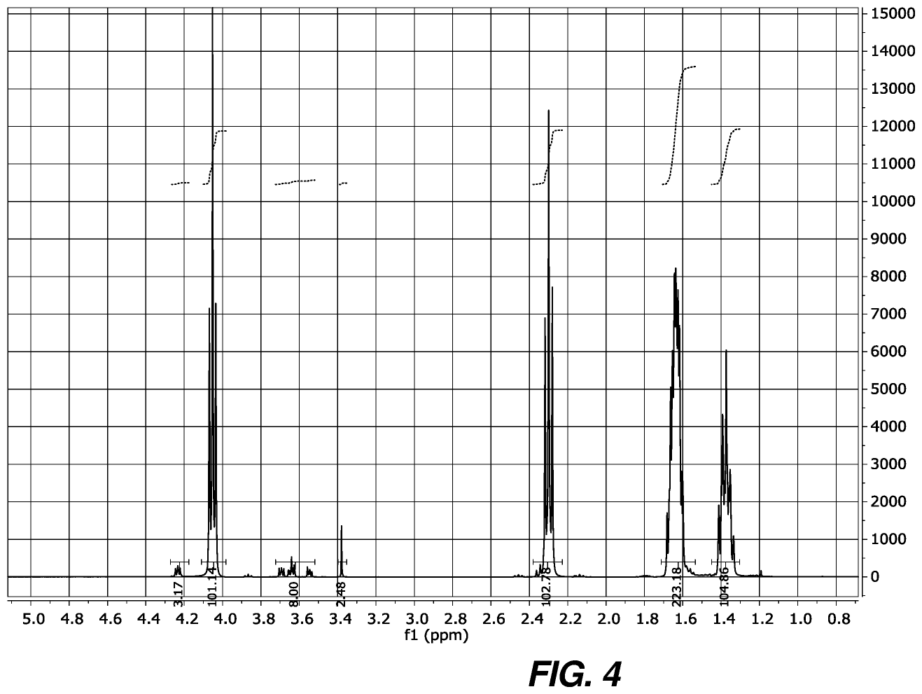

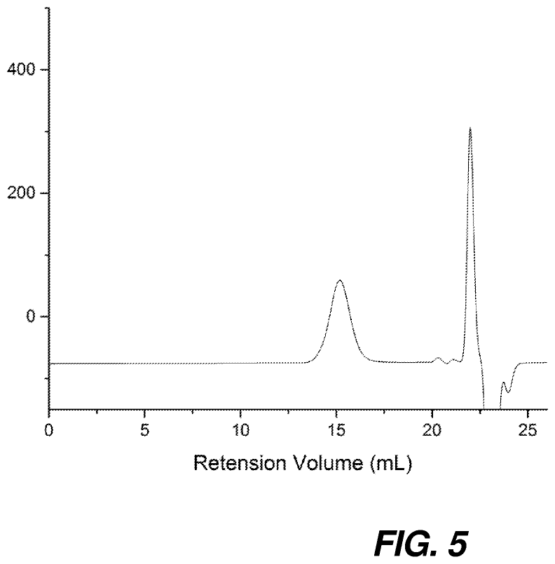

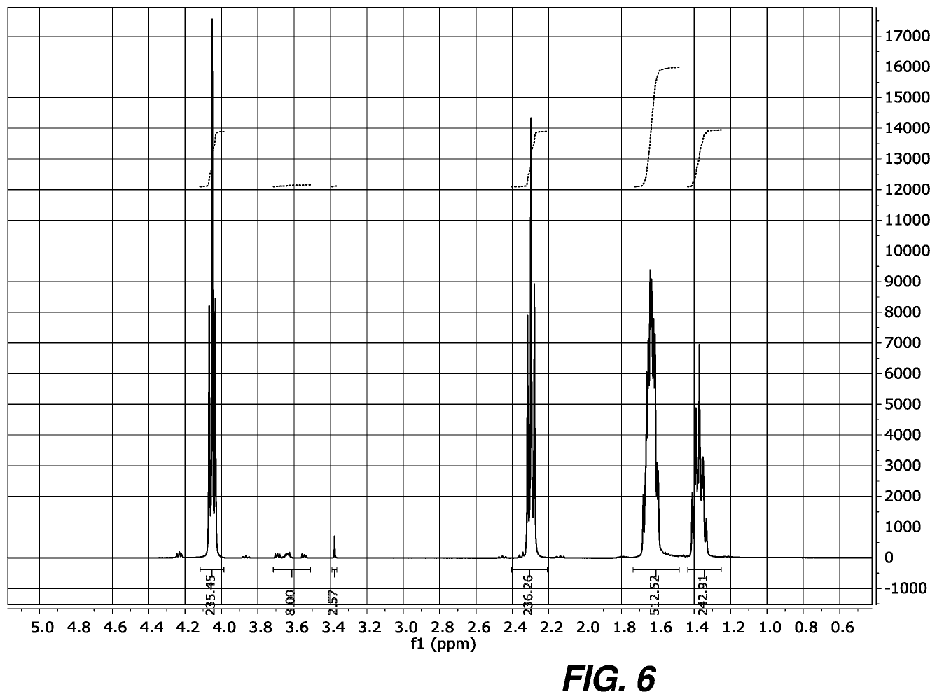

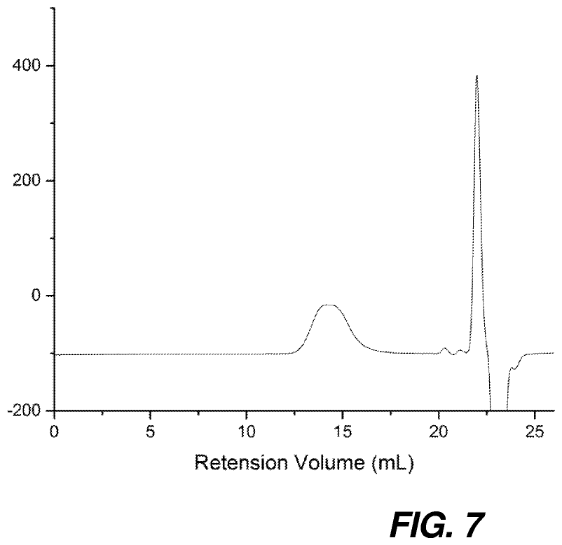

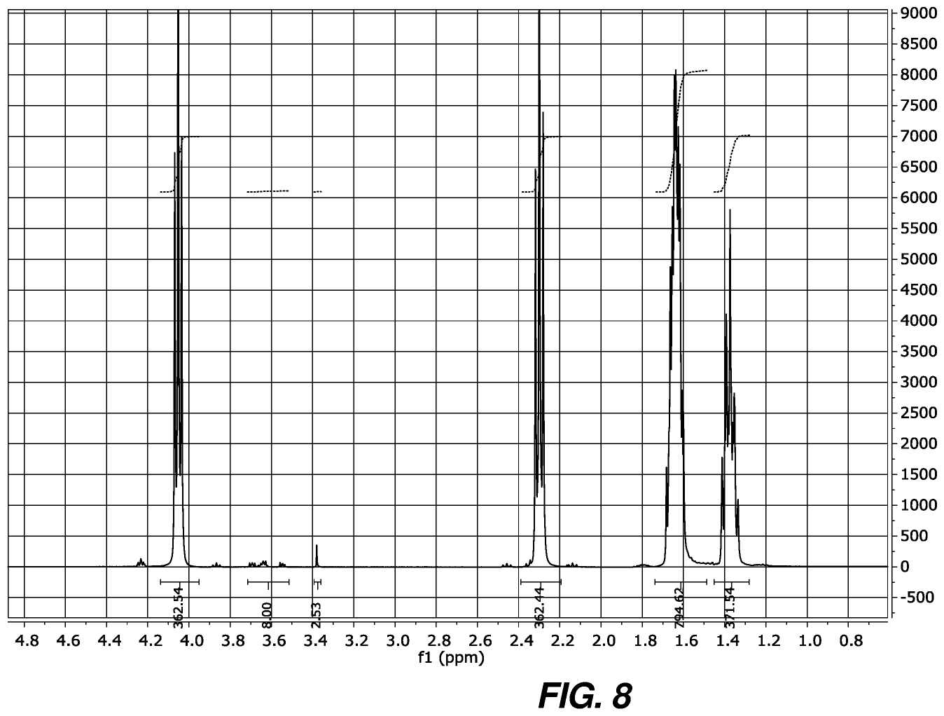

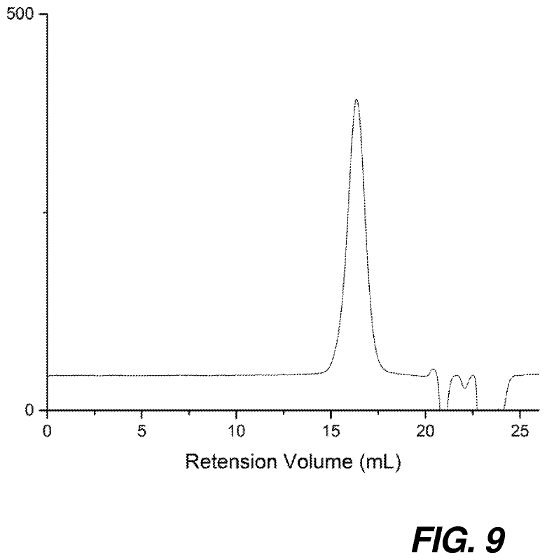

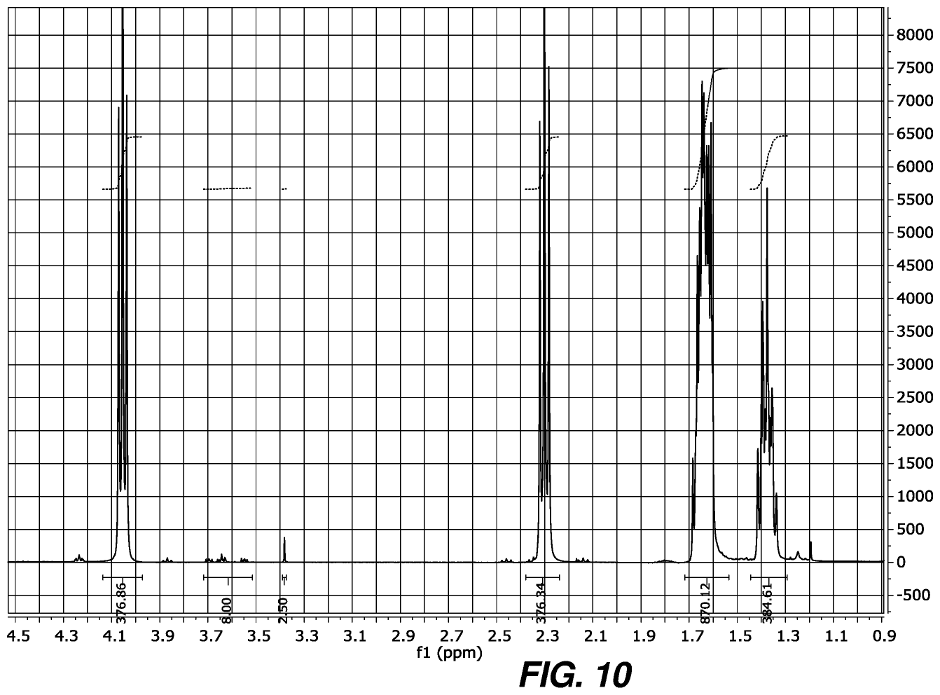

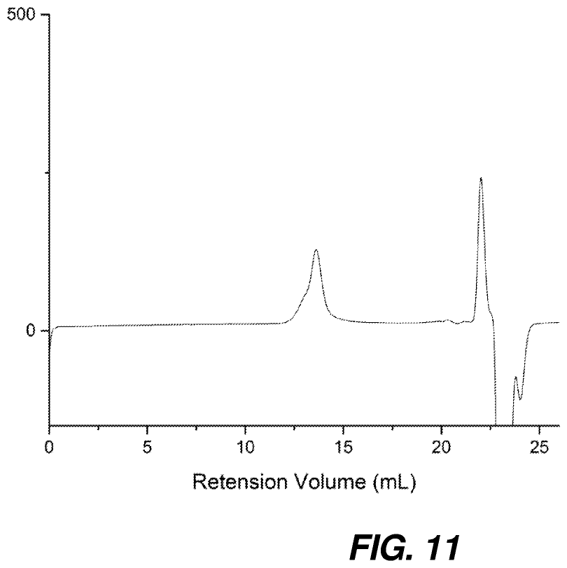

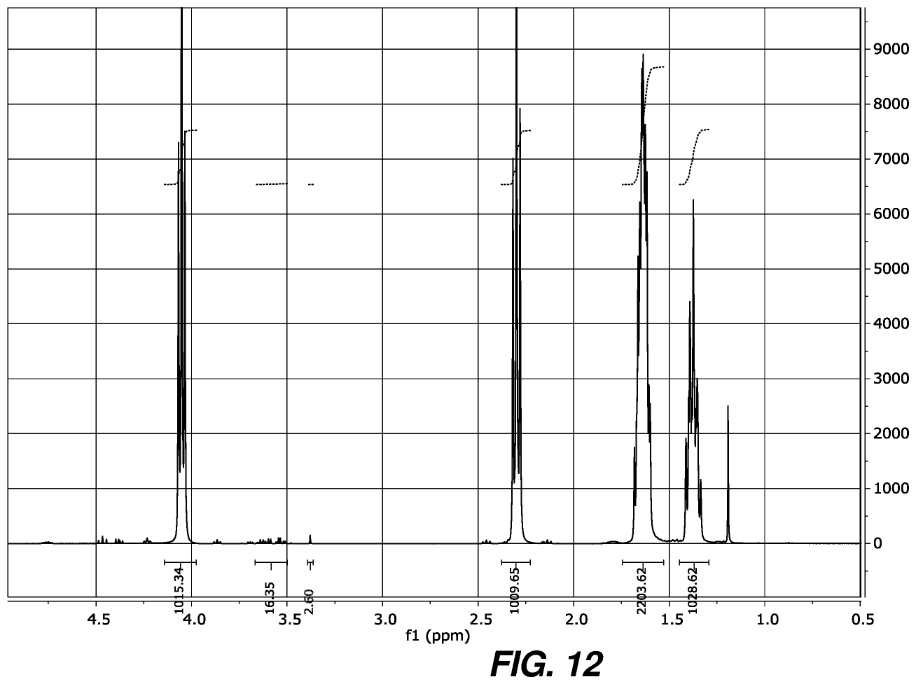

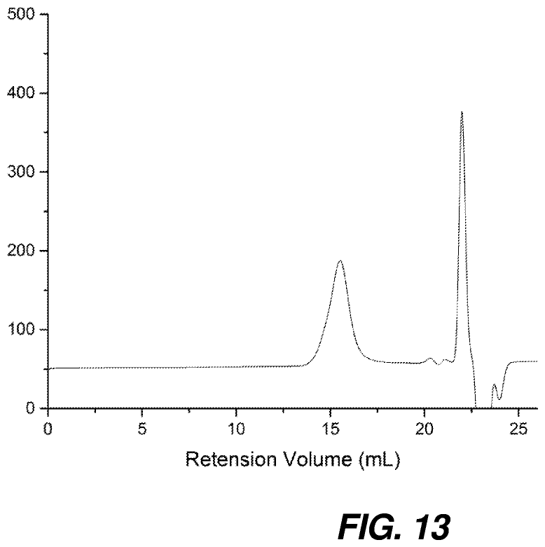

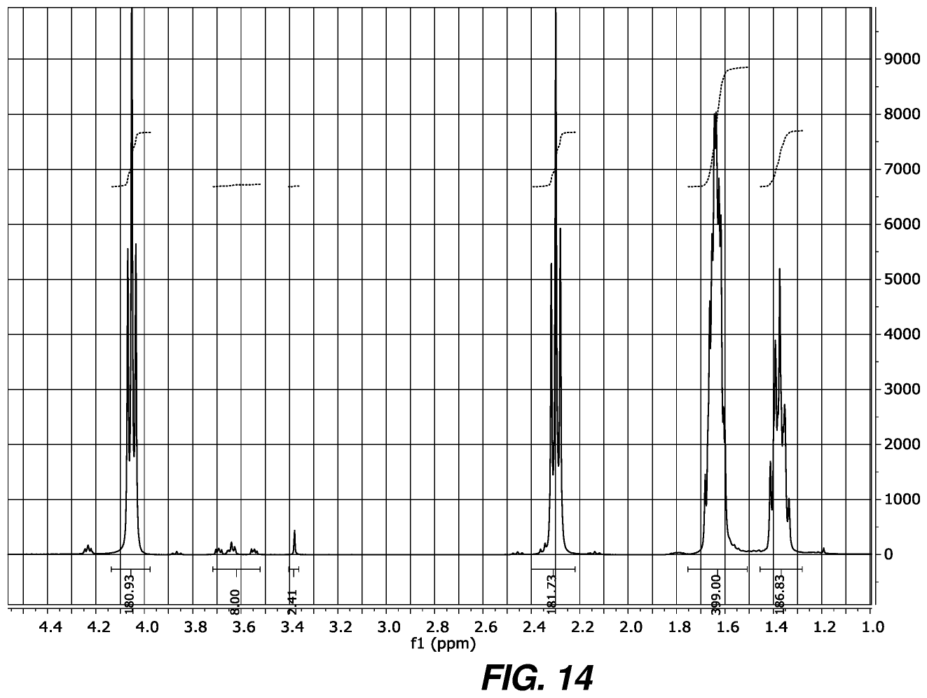

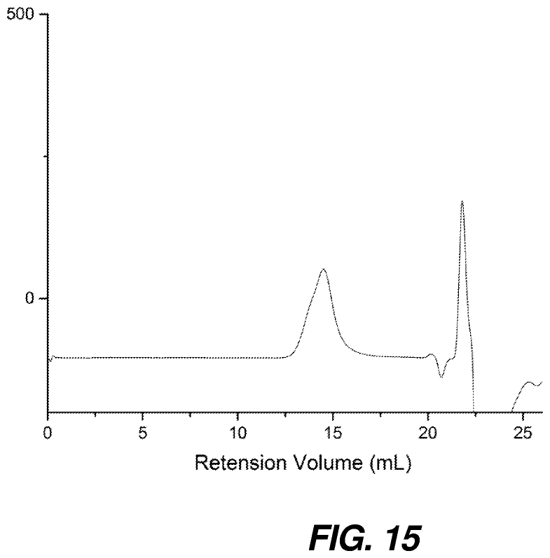

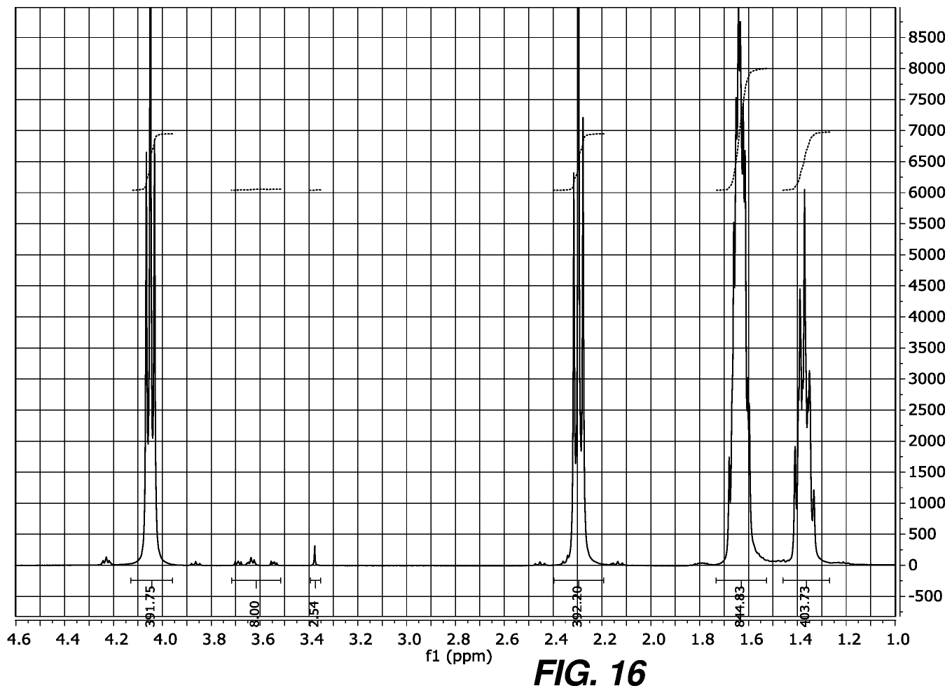

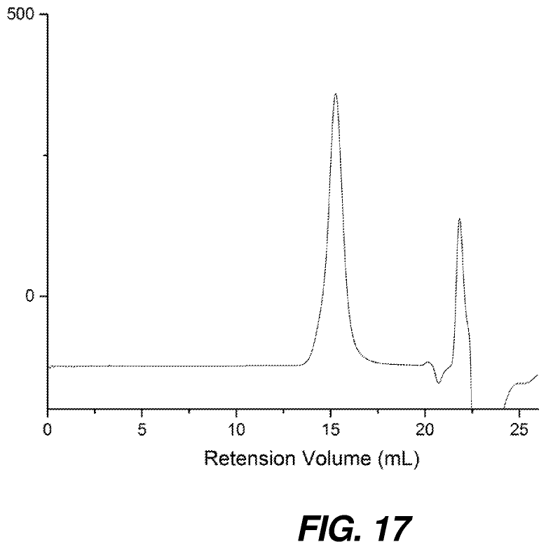

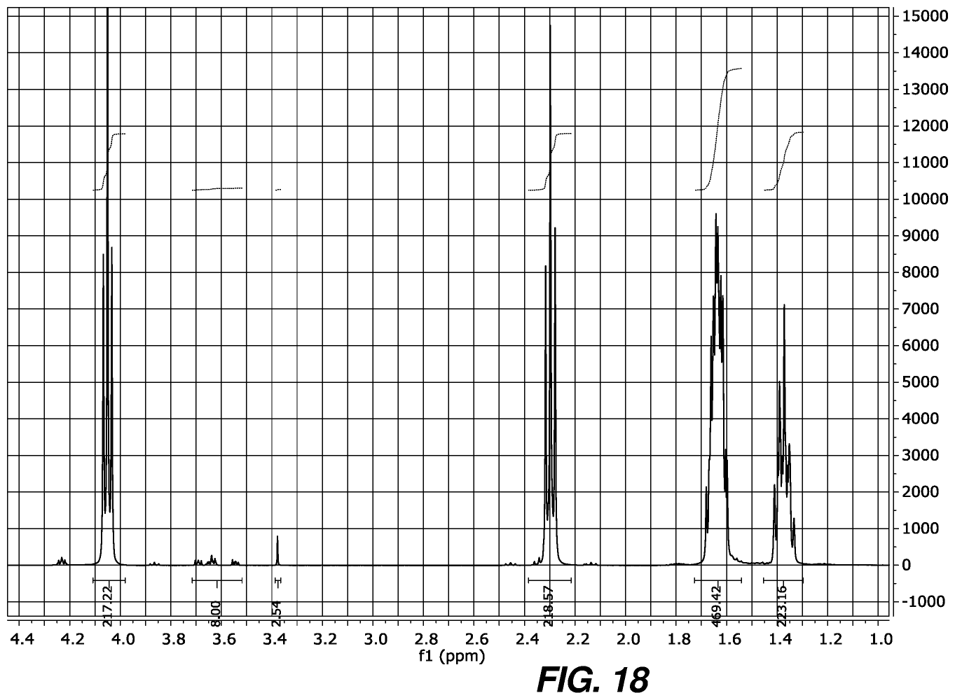

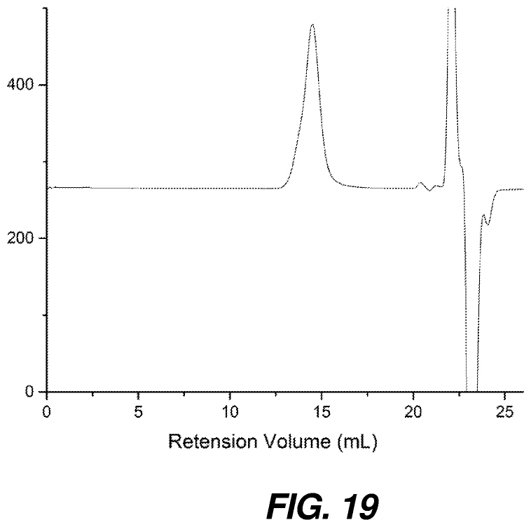

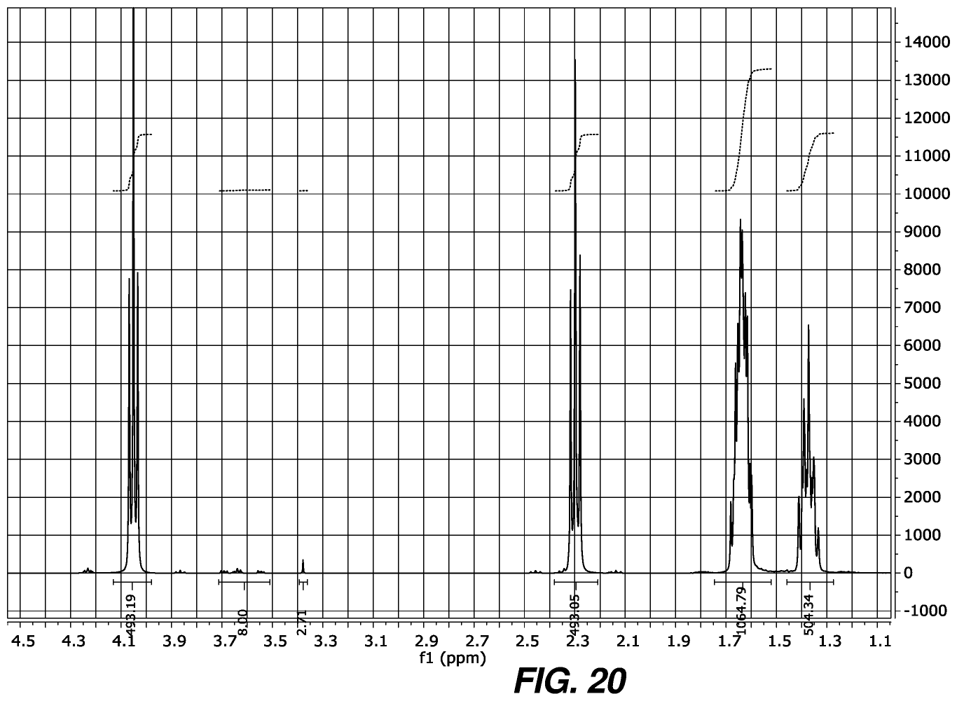

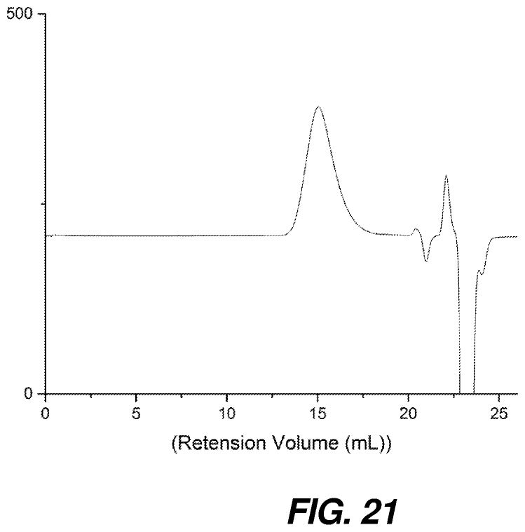

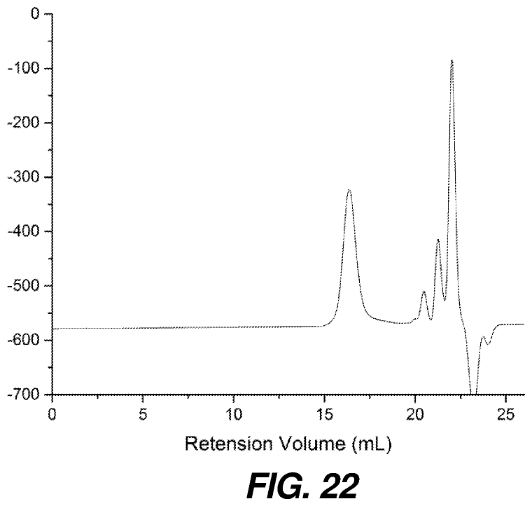

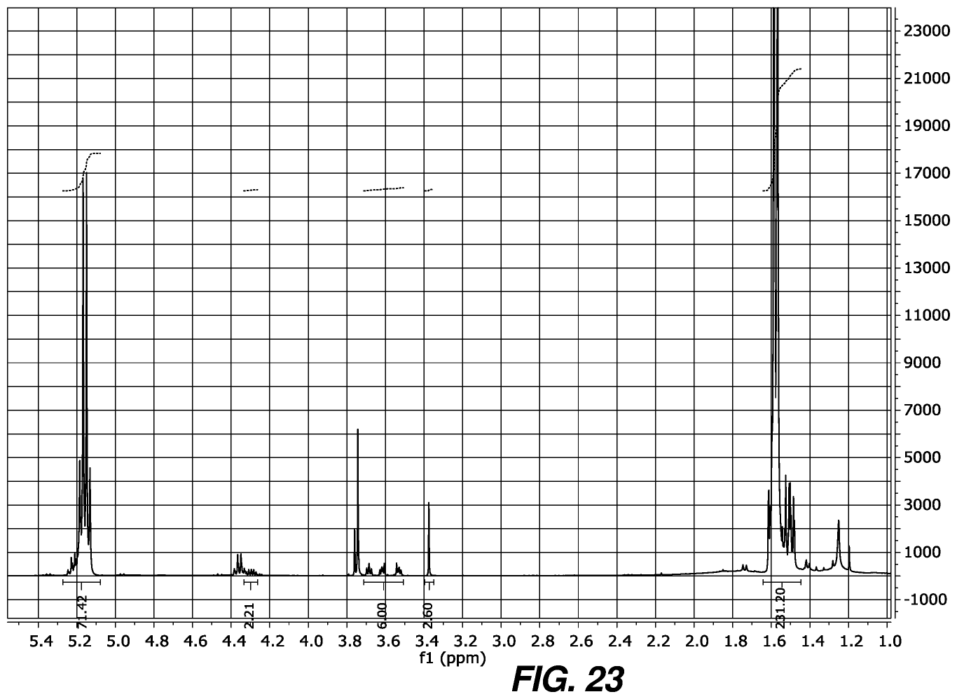

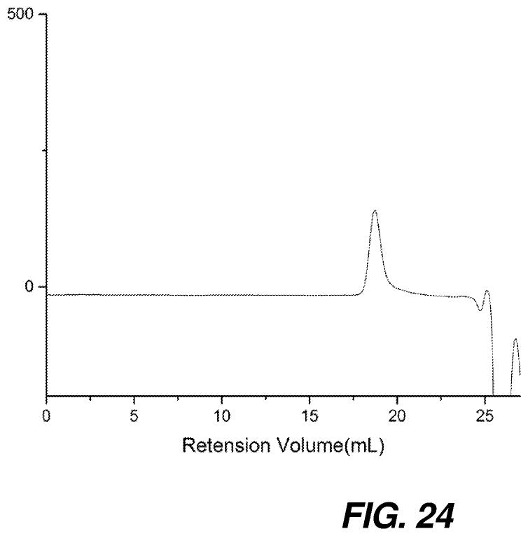

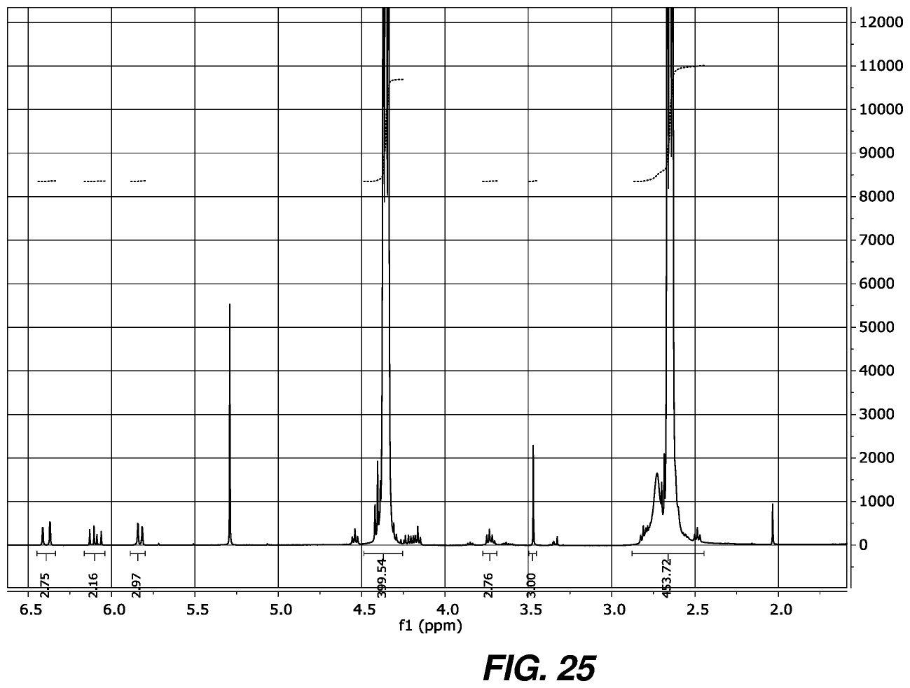

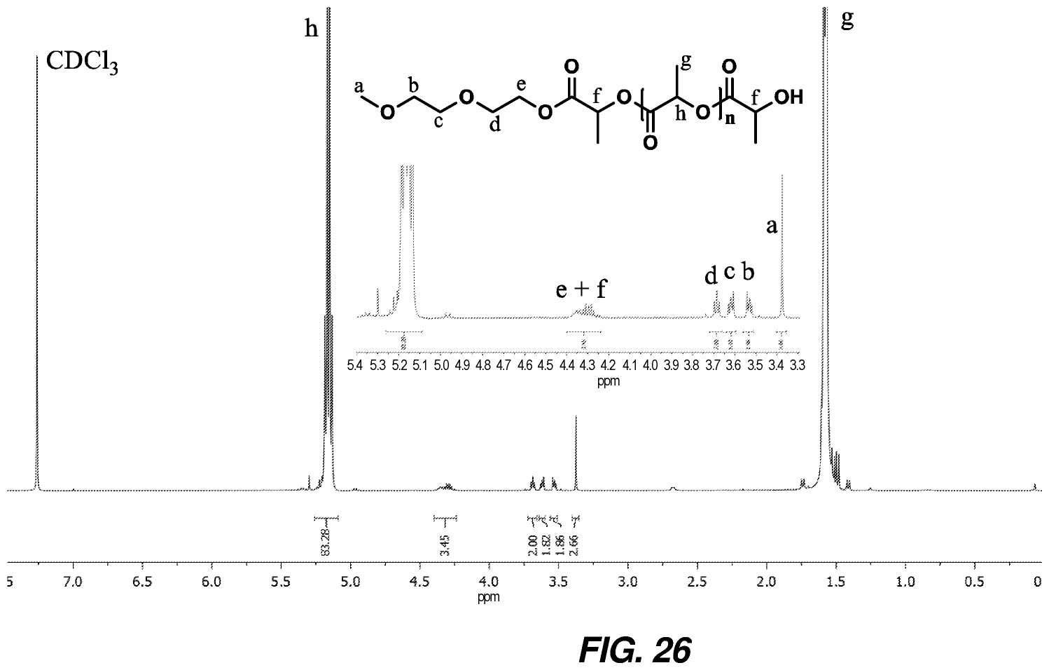

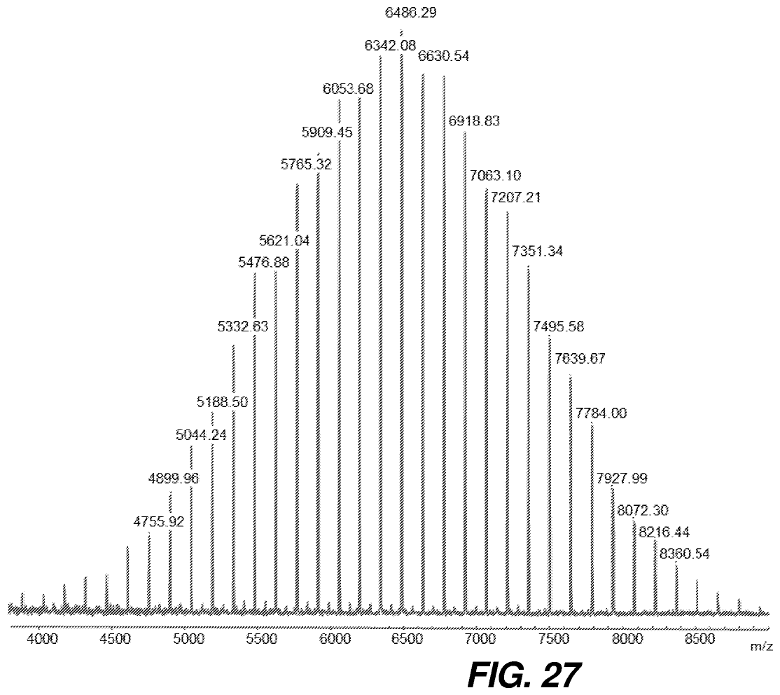

FIG. 1 is a flowchart of a method 100 of making a polyester compound, according to one or more embodiments of the present disclosure. The method 100 comprises adding 101 an initiator to a reaction medium, charging 102 the reaction medium with carbon dioxide, and adding 103 a cyclic ester compound to the reaction medium. In an embodiment, the method 100 comprises adding 101 an initiator to a reaction medium, wherein the initiator is an alkali metal alkoxide, charging the reaction medium with an amount of carbon dioxide to suppress transesterification reactions, and adding a cyclic ester compound to the reaction medium, wherein the cyclic ester compound is polymerized to form the polyester compound. In this way, the method 100 provides for the controlled/living polymerization of lactones and suppresses, or at least decreases, the occurrence of undesirable side reactions, such as transesterification.

At step 101, an initiator is added 101 to the reaction medium. Adding 101 may generally include any process and/or method of placing one component in or on another component, joining one or more components with another component, and/or bringing two or more components together, as in contacting. The components may be in contact or in immediate/close proximity. Accordingly, adding may include one or more of pouring, dumping, mixing, depositing, providing, placing, putting, inserting, injecting, introducing, dropping, contacting, and any other methods known in the art.

The initiator may be an alkali metal alkoxide. The initiator may include any alkali metal. For example, the initiator may be one or more of lithium alkoxide, sodium alkoxide, potassium alkoxide, rubidium alkoxide, caesium alkoxide, and francium alkoxide. In many embodiments, the initiator may be one or more of lithium alkoxide, sodium alkoxide, and potassium alkoxide. In a preferred embodiment, the initiator is lithium alkoxide. The initiator may include any alkoxide known in the art. In many embodiments, the initiator may be one or more of an alkali metal monomethyl diethylene glycoxide and alkali metal carbonate. In many embodiments, the initiator may be one or more of lithium carbonate and lithium monomethyl diethylene glycoxide.

A solvent may further be added to the reaction medium. For example, in an embodiment, the solvent may be added to the reaction medium with the initiator during step 101. In many embodiments, the solvent added to the reaction medium is a non-coordinating solvent, which have very weak interaction with the solutes. The non-coordinating solvent may include one or more of dichloromethane (DCM), toluene, tetrahydrofuran (THF), and benzene. In an embodiment, a single non-coordinating solvent may be added to the reaction medium. In another embodiment, two or more non-coordinating solvents may be added to the reaction medium. For example, a mixture of dichloromethane and tetrahydrofuran may be added to the reaction medium.

The reaction medium may include any reaction medium suitable for making a polyester compound. In particular, the reaction medium may include any reaction medium known in the art as being suitable for polymerizations and capable of performing the method 100.

At step 102, the reaction medium is charged 102 with carbon dioxide. Charging 102 may include any process and/or method of feeding carbon dioxide to the reaction medium. Accordingly, charging may include one or more of flowing, passing, injecting, pumping, introducing, providing, and any other methods known in the art. In many embodiments, at step 102, the reaction medium is charged 102 with an amount of carbon dioxide sufficient to suppress transesterification reactions.

The amount of carbon dioxide charged to the reaction vessel may range from about one time to about 10 times the amount of initiator (e.g., growing alkoxides). In many embodiments, an excess, or more preferably a slight excess, of carbon dioxide relative to the initiator may be charged to the reaction medium. For example, about 0 to about 3 equivalents of carbon dioxide relative to the initiator (e.g., growing alkoxide) may be charged to the reaction medium. In a preferred embodiment, about 0.5 to about 3 equivalents of carbon dioxide relative to the initiator is charged to the reaction medium. For example, about 0.5 equivalents, about 1.1 equivalents, about 1.5 equivalents, about 2 equivalents, about 2.5 equivalents, and/or about 3 equivalents of carbon dioxide relative to the initiator is charged to the reaction medium. Generally, more CO₂ related to the imitator is charged in order to adapt the more active cyclic ester monomers polymerized.

Charging the reaction vessel with carbon dioxide may partially and/or completely suppress, or at least decrease, undesirable side reactions, such as transesterification reactions. Transesterification may include intermolecular transesterification and/or intramolecular transesterification. In many embodiments, transesterifications are undetectable. To suppress transesterification, the reaction medium is charged with carbon dioxide. Upon charging the reaction vessel with carbon dioxide, a fast equilibrium may take place between a dormant species and an active species. The dormant species generally cannot initiate the polymerization (e.g., anionic ring-opening polymerization) of cyclic esters. An example of the dormant species is a carbonate species. The active species, on the other hand, is able to initiate polymerization of cyclic-esters. An example of the active species is an alkoxide species and/or mixed alkoxide-carbonate species. In many embodiments, the active species selectively and preferably attacks the monomer rather than the polyester chains for transesterification.

In an embodiment, the fast equilibrium is between two tetrameric species. One of the tetrameric aggregates may be a dormant species comprising four carbonates (e.g., (RCO₃Li)₄). The other tetrameric aggregate may be an active species comprising three carbonates and one alkoxide (e.g., (RCO₃Li)₃(ROLi)).

At step 103, a cyclic ester compound is added 103 to the reaction medium. Adding 103 may include any of the methods and/or processes described above with respect to adding 101. The cyclic ester compound may include any lactone. For example, the cyclic ester compound may include any 3-membered to 7-membered lactone, such as one or more of acetolactone, propiolactone, butyrolactone, valerolactone, and caprolactone. In many embodiments, the cyclic ester compound is one or more of caprolactone, butyrolactone, valerolactone, and lactide. For example, the cyclic ester compound may be ε-caprolactone, L-lactide, β-propiolactone, γ-butyrolactone, and δ-valerolactone. In a preferred embodiment, the cyclic ester compound is one or more of ε-caprolactone, L-lactide, and β-propiolactone.

The polyester compound formed may include any polyester compound capable of being formed from the cyclic ester compound. The cyclic ester compound may be polymerized via anionic ring-opening polymerization of cyclic esters. The polyester compounds may be formed with controlled molar mass and/or narrow molar mass distribution. The polydispersity index may range from about 1 to about 3. In many embodiments, the polydispersity index ranges from about 1 to about 2. In preferred embodiments, the polydispersity index is less than about 2.

### Example

Conventional anionic ring opening of polymerization (AROP) of cyclic esters suffers from the non-selective and concomitant attack of the monomer and of the polymer chains by the growing active species, which results in polyester samples with uncontrolled molar masses and broad polydispersity due to the competition between propagation and transesterification reactions. In this report, we describe a new AROP system mediated by a controlled amount of CO₂ which prevents transesterification reactions from occurring. Using lithium monomethyl diethylene glycoxide (MEEOLi) as initiator and 1.5 eq. of CO₂, ε-caprolactone could be polymerized under truly “living” conditions in dichloromethane (DCM) at 70° C., as evidenced by the control of molar masses, the narrow polydispersity indexes (Mn up to ˜40 kg/mol, D<1.16) and also by successful chain extension experiments. Lithium carbonate used as initiator in the presence of 0.5 eq. of CO₂ afforded similar polymerization results. Experiments carried out with other alkoxide salts and solvents demonstrate that CO₂ is indispensable, as well as lithium and non-coordinating solvents for the suppression of transesterifications. A similar strategy was applied for the AROP of L-lactide (LLA). At −20° C., LLA could be polymerized under living conditions with undetectable level of transesterification as demonstrated by MALDI-ToF analysis. To account for the polymerization mechanism occurring in the presence of a slight excess of CO₂, we resorted to computational studies. It appears that a fast equilibrium takes place between 2 tetrameric aggregates, one dormant comprising 4 carbonates (RCO₃Li)₄ and an active one involving 3 carbonates and one alkoxide (RCO₃Li)₃(ROLi). The latter is shown to selectively ring-open cyclic ester without indulging in transesterifications like (ROLi)₄ precursors.

TABLE 1
Polymerization results of ε-caprolactone, L-lactide using lithium
monomethyl diethylene glycoxide as initiator under different conditions

| | | Targeted | T | Time | | CO₂ | Conv. | Mₙ₍ₜₕₑₒ₎ | M_{n(NMR)} | M_{n(GPC)}^{e} | |
|---|---|---|---|---|---|---|---|---|---|---|---|
| Entry | M^{a} | DP | (° C.) | (min) | Solvent | (Eq) | (%) | (10³ g/mol) | (10³ g/mol) | (10³⁹ g/mol) | Ð |
| 1 | CL | 50 | RT | <1 | DCM | 0 | 75 | 4.30 | 10.7 | 9.30 (5.20) | 2.17 |
| 2 | CL | 2000 | RT | 1 | DCM | 0 | 85 | 35.65 | 15.2 | 74.9 (41.9) | 1.99 |
| 3 | CL | 50 | 70 | 45 | DCM | 1.5 | 95 | 5.20 | 5.40 | 9.60 (5.40) | 1.10 |
| 4 | CL | 100 | 70 | 90 | DCM | 1.5 | 95 | 10.8 | 10.9 | 19.3 (10.8) | 1.14 |
| 5 | CL | 200 | 70 | 165 | DCM | 1.5 | 90 | 20.5 | 21.4 | 36.8 (20.6) | 1.15 |
| 6 | CL | 500 | 70 | 270 | DCM | 1.5 | 74 | 42.2 | 56.3 | 69.0 (38.6) | 1.16 |
| 7 | CL | 100 + 100 | 70 | 135 | DCM | 1.5 | 70 | 15.5 | 14.5 | 27.7 (15.5) | 1.18 |
| 8 | CL | 100 | 70 | 120 | DCM | 1.5 | >99% | 11.4 | 16.7 | 28.4 (15.9) | 1.56 |
| 9 | CL | 50 | 70 | 12 | THF | 1.5 | 90 | 5.1 | 5.0 | 9.2 (5.1) | 1.28 |
| 10 | CL | 100 | 70 | 15 | THF | 1.5 | 95 | 9.5 | 9.20 | 19.9 (11.1) | 1.29 |
| 11 | CL | 200 | 70 | 45 | THF | 1.5 | 73 | 16.6 | 22.2 | 29.9 (16.7) | 1.30 |
| 12 | CL | 100 | 70 | 15 | THF | 1.5 | 80 | 8.9 | 9.2 | 16.0 (9.0) | 1.17 |
| 13 | CL | 50 | 70 | 55 | Tol | 1.5 | 98 | 5.6 | 5.5 | 10.1 (5.6) | 1.12 |
| 14 | CL | 100 | 70 | 70 | Tol | 1.5 | 92 | 10.5 | 11.1 | 18.7 (10.5) | 1.11 |
| 15 | CL | 200 | 70 | 135 | Tol | 1.5 | 90 | 20.5 | 22.7 | 35.3 (20.0) | 1.15 |
| 16 | CL | 100 | 70 | 120 | DCM | 2.5 | 98 | 11.2 | 10.7 | 20.0 (11.2) | 1.16 |
| 17 | CL^{b} | 50 | 70 | 4 | DCM | 0 | 99 | 5.6 | 6.7 | 12.5 (7.0) | 1.37 |
| 18 | CL^{b} | 50 | 70 | 60 | DCM | 0.5 | 98 | 5.6 | 5.6 | 10.1 (5.6) | 1.15 |
| 19 | CL^{b} | 100 | 70 | 5 | DCM | 0 | 84 | 9.5 | — | 17.2 (9.6) | 1.31 |
| 20 | CL^{c} | 100 | 80 | 3d | DCM | 1.1 | 0 | — | — | — | — |
| 21 | CL^{d} | 200 | 70 | 2d | DCM | 1.1 | 0 | — | — | — | — |
| 22 | LLA | 100 | 50 | 35 | DCM | 3.0 | 30 | 4.3 | 2.4 | 4.6 (2.6) | 1.18 |
| 23 | LLA | 100 | 20 | 150 | DCM | 3.0 | 20 | 2.9 | 3.0 | 5.6 (3.2) | 1.07 |
| 24 | LLA | 100 | −20 | 26 h | DCM/THF | 3.0 | 50 | 7.20 | 6.0 | 11.5 (6.7) | 1.08 |
| 25 | LLA | 100 | −20 | 30 | DCM/THF | 0 | 50 | 8.6 | 7.7 | 6.8 (3.9) | 1.22 |
| 26 | LLA | 100 | 50 | 15 | DCM | 3.0 | 50 | 7.2 | 5.1 | 8.6 | 1.11 |
| 27 | PL | 50 | 70 | 20 h | DCM | 1 atm | 90 | 3.2 | 3.8 | 3.7 | 1.12 |

*: ^{a}CL = ε-caprolactone, LLA = L-Lactide, PL = β-propiolactone.
^{b}Lithium carbonate as initiator.
^{c}potassium monomethyl diethylene glycoxide used as initiator.
^{d}CI is carbene (1,3-diisopropylimidazol-2-ylidene) as initiator.
^{e}GPC determined with polystyrene standards, the values in bracket were corrected with a correction factor of 0.56 for PCL and with 0.58 for PLLA.

### Materials and Characterizations

All reactions were carried out under a dry and oxygen-free argon atmosphere in a Braun Labmaster glovebox. nBuLi and CL, L-LA and diethylene glycol monomethyl ether were purchased from Aldrich. Tetrahydrofuran (THF) and toluene were distilled from sodium/benzophenone mixture before used. Dichloromethane, 1,4-dioxane and ε-CL was distilled from CaH₂ after stirring two days. L-LA was purified by two times recrystallization from ethyl acetate followed by lyophilization from dry dioxane. Diethylene glycol monomethyl ether was purified by azeotropic distillation from toluene. CO₂ (99.995%) from Abdullah Hashim Industrial & Gas Co. was further purified by passing through a CO₂ purifier (VICI Co., US). All ¹H and ¹³C NMR spectra were recorded on a Bruker AVANCE 111-400 Hz instrument. The NMR experiments for diffusion coefficient measurement were carried out at 298K on a Bruker AVANCE III 600 MHz SB NMR spectrometer equipped with a 5 mm Z-gradient BBFO NMR probe. The standard diffusion pulse sequence using DSTE with 3 spoil gradients and LED was applied during the measurements and 32 points were collected for diffusion coefficient calculation by varying the strength of the pulsed field gradient for each point linearly from 2% to 98%. GPC were recorded by VISCOTEK VE2001 equipped with Styragel HR2 THF (1 mL/min) as eluent. Narrow molar mass polystyrene standards were used to calibrate the instrument. MALDI-TOF MS experiments were carried out by using trans-2-[3-(4-t-butyl-phenyl)-2-methyl-2-propenylidene] malononitrile (DCTB) as the matrix in THF and NaTFA as ionizing agent on a Bruker Ultrafex III MALDI-TOF mass spectrometer (Bruker Daltonik, Bremen, Germany). 10 mg sample, 40 mg DCTB and 10 mg NaTFA were dissolved in 1 mL THF in separate vials to make a combination of 10 μL:20 μL:5 μL mixture in respective order and 1 μL from that mixture was loaded over the plate.

### Representative Procedures

1. Representative procedure of CO₂ mediated controlled anionic ROP of ε-caprolactone in dichloromethane: A pre-dried 30 mL glass schlenk tube (80 mm×28 mm) composed of two rotaflo stopcocks and fitted with magnetic stirring bar was used to carry out this reaction. 22.1 mg of lithium alkoxide (175 μmol) was added in 0.5 mL of dichloromethane in the glass schlenk tube under argon condition. The glass schlenk tube was taken out from the glove box, connected to vacuum and removed argon after cooling down the solvent in liquid N2. 5.8 mL of purified CO₂ (262 μmol) was taken and rapidly injected into the head space of schlenk tube through rubber septa, and allowed CO₂ to react with lithium alkoxide for 10 minutes in order to form carbonate species. Then the solution of ε-caprolactone 1 mL (8.76 mmol) in 1.5 mL DCM was injected into the reactor. The polymerization was subsequently carried out under stirring at 70° C. After a reaction time of 45 minutes, the reaction mixture was quenched with few drops of 5% HCl in methanol. The polymer was precipitated from cold methanol and dried in vacuum oven before estimating the conversion. The obtained polycaprolactone was characterized by NMR, GPC and MALDI-TOF. The results are listed in Table 1 Entry 3.

2. Representative procedure of CO₂ mediated controlled anionic ROP of ε-caprolactone in toluene: A pre-dried 30 mL glass schlenk tube (80 mm×28 mm) composed of two rotaflo stopcocks and fitted with magnetic stirring bar was used to carry out this reaction. Inside the glove box under argon, 11 mg of lithium alkoxide (87 μmol) was added in 0.5 mL of toluene in the glass schlenk tube under argon condition. The glass schlenk tube was taken out from the glove box, connected to vacuum and removed argon after cooling down the solvent. 2.9 mL of purified CO₂ (131 μmol) was taken and rapidly injected into the head space of schlenk tube through rubber septa, and allowed to react with lithium alkoxide for 10 minutes in order to form carbonate species. Then the solution of ε-caprolactone 1 mL (8.76 mmol) in 4.5 mL toluene was injected into the reactor. Then, the polymerization was carried out under stirring at 70° C. After reacting for 70 minutes, the reaction mixture was quenched with few drops of 5% HCl in methanol. The polymer was precipitated from cold methanol and dried in vacuum oven to estimate the conversion. The obtained polycaprolactone characterized by NMR and GPC. The results were listed in Table 1 entry 14.

3. Representative procedure of CO₂ mediated controlled anionic ROP of ε-caprolactone in tetrahydrofuran: A pre-dried 30 mL glass schlenk tube (80 mm×28 mm) composed of two rotaflo stopcocks and fitted with magnetic stirring bar was used to carry out this reaction. Inside the glove box under argon, 11 mg of lithium alkoxide (87 μmol) was added in 0.5 mL of THF in the glass schlenk tube under argon condition. The glass schlenk tube was taken out from the glove box, connected to vacuum and removed argon after cooling down the solvent. 2.9 mL of purified CO₂ (131 μmol) was taken and rapidly injected into the head space of schlenk tube through rubber septa, and allowed to react with lithium alkoxide for 10 minutes in order to form carbonate species. Then the solution of ε-caprolactone 1 mL (8.76 mmol) in 4.5 mL THF was injected into the reactor. Then, the polymerization was carried out under stirring at 70° C. After reacting for 70 minutes, the reaction mixture was quenched with few drops of 5% HCl in methanol. The polymer was precipitated from cold methanol and dried in vacuum oven to estimate the conversion. The obtained polycaprolactone characterized by NMR and GPC. The results were listed in Table 1 entry 12.

4. Representative procedure of CO₂ mediated controlled anionic ROP of L-Lactide in dichloromethane: A pre-dried 30 mL glass schlenk tube (80 mm×28 mm) composed of two rotaflo stopcocks and fitted with magnetic stirring bar was used to carry out this reaction. Inside the glove box under argon, 4.37 mg of lithium alkoxide (35 μmol) was added in 0.5 mL of dichloromethane in the glass schlenk tube under argon condition. The glass schlenk tube was taken out from the glove box, connected to vacuum and removed argon after cooling down the solvent. 2.3 mL of purified CO₂ (102 μmol) was taken and rapidly injected into the head space of schlenk tube through rubber septa, and allowed to react with lithium alkoxide for 10 minutes in order to form carbonate species. Then the solution of L-Lactide 500 mg (3.46 mmol) in 2.5 mL of dichloromethane was injected into the reactor. Then, the polymerization was carried out under stirring at 50° C. After reacting for 15 minutes, the reaction mixture was quenched with few drops of 5% HCl in methanol. The polymer was precipitated from cold hexane and dried in vacuum oven to estimate the conversion. The obtained polylactide characterized by NMR and GPC. The results were listed in Table 1 entry 26.

5. Representative procedure of CO₂ mediated controlled anionic ROP of β-propiolactone in dichloromethane: A pre-dried 30 mL glass schlenk tube (80 mm×28 mm) composed of two rotaflo stopcocks and fitted with magnetic stirring bar was used to carry out this reaction. Inside the glove box under argon, 11 mg of lithium alkoxide (69 μmol) was added in 0.5 mL of dichloromethane in the glass schlenk tube under argon condition. The glass schlenk tube was taken out from the glove box, connected to vacuum and removed argon after cooling down the solvent. 1 atmosphere CO₂ was passed to the shlenk tube, and allowed to react with lithium alkoxide for 10 minutes in order to form carbonate species. Then the solution of β-propiolactone 250 mg (3.46 mmol) in 1 mL of dichloromethane was injected into the reactor. Then, the polymerization was carried out under stirring at 70° C. After reacting for 20 hours, the reaction mixture was quenched with few drops of 5% HCl in methanol. The polymer was precipitated from cold hexane and dried in vacuum oven to estimate the conversion. The obtained polypropiolactone characterized by NMR and GPC. The results were listed in Table 1 entry 27.

6. Representative procedure of CO₂ mediated controlled anionic ROP of L-Lactide in dichloromethane: A pre-dried 30 mL glass schlenk tube (80 mm×28 mm) composed of two rotaflo stopcocks and fitted with magnetic stirring bar was used to carry out this reaction. Inside the glove box under argon, 2.1 mg of lithium alkoxide (17 μmol) was added in 0.5 mL of dichloromethane in the glass schlenk tube under argon condition. The glass schlenk tube was taken out from the glove box, connected to vacuum and removed argon after cooling down the solvent in liquid N₂. 1.2 mL of purified CO₂ (51 μmol) was taken and rapidly injected into the head space of schlenk tube through rubber septa, and allowed CO₂ to react with lithium alkoxide for 10 minutes in order to form carbonate species. Then the solution of 250 mg of L-LA dissolved in 0.55 mL DCM and 0.45 mL of THF was injected into the tube, the polymerization was carried out under stirring at −20° C. After reacting for 26 h, the reaction mixture was quenched with few drops of 5% HCl in methanol. The polymer was precipitated from cold hexane and dried in vacuum oven before estimating the conversion. The obtained polylactide was characterized by NMR and GPC and MALDI-TOF. The results are listed in Table 1 Entry 24.

### Discussion

Aliphatic polyesters are of great interest for applications ranging from microelectronics, adhesives, packaging to biomedical devices and pharmaceuticals. The ring opening polymerization (ROP) of cyclic esters is generally preferred over polycondensation for the synthesis of aliphatic polyesters as it affords samples of high and controlled molar masses. Among all the methods tried to efficiently ring-open cyclic esters, AROP has certainly been the most investigated, yielding mixed results depending on the cyclic ester considered. For instance, β-propiolactone could be polymerized under “living” conditions using alkali carboxylates, but ε-caprolactone could not as both propagation and intra- and intermolecular transesterification reactions occur concomitantly as shown in Scheme 1.

Logically attempts were made to engineer the reactivity of these alkali metal alkoxides by associating them with bulky and complex ligands with the view of suppressing transesterification reactions. For example, bulky phenolate ligands along with lithium complexes were used and showed the “livingness” of L-lactide polymerization under these conditions. The use of organic cations derived from carbenes or of weak bases proved also efficient to bring about controlled polymerization. At present the most utilized methods of aliphatic polyester synthesis resort to aluminum and tin alkoxides to polymerize monomers such as ε-caprolactone and L-lactide by coordination and insertion of the two monomers.

Besides manipulating the active species responsible for propagation and fine-tuning their reactivity, another approach has been to selectively activate the monomers as a means to favor propagation over scrambling reactions. Using bis(2,6-di-t-butylphenoxy)ethyl aluminum to activate ε-caprolactone, ε-caprolactone can be successfully anionically polymerized under controlled/living conditions. Recently, the ability of dithioureas to selectively activate the carbonyl function of both lactones and lactides has been demonstrated, also observed that propagation is vastly favored over transesterification, to obtain a truly living polymerization of cyclic esters. The present disclosure describes a totally novel strategy based on the use of CO₂ along with simple lithium alkoxides as a means to bring about the controlled/living anionic ring opening polymerization of cyclic esters.

CO₂ is an abundant, inexpensive, and non-toxic renewable C1 resource that is considered for the production of value-added chemicals and materials, such as urea, carbonates, methanol, salicylic acid, and polycarbonates, etc. Attempts were made at polymerizing cyclic esters in supercritical CO₂ used as a “green” solvent: in the latter case lower reactivities were reported with respect to those observed in regular solvents due to the formation of carbonate species. CO₂ has also been used to reversibly trap certain species and switch the properties of the latter from polar to nonpolar, hydrophobic to hydrophilic, and dormant to active species. The switch from dormant to active species and vice-versa was for instance applied to reversibly stop and resume polymerization of cyclic esters. Upon heating, carbene-CO₂ adducts used as precatalyst released carbenes which thus serves as initiator for the ROP of cyclic esters. In the case of cyclic esters, the “regulation” of the polymerization of cyclic esters by alternating “on/off” cycles of CO₂ and nitrogen flow has been reported.

More recently, the one-pot synthesis of well-defined poly(carbonate-b-ester) block copolymers through sequential selective polymerization of epoxides and CO₂, and lactones was reported. These results demonstrated that, in the presence of CO₂, alkoxides are transformed into carbonates: the latter are inactive towards cyclic esters but upon removal of CO₂ carbonate chain ends release their terminal CO₂ and the ROP of cyclic esters can resume.

The present disclosure provides that upon adding a precise amount of CO₂ to growing alkoxides, the ROP of cyclic esters is not stopped as described in recent reports, but can proceed under living conditions, being efficiently prevented from competing transesterification reactions.

### ROP of ε-Caprolactone by Lithium Alkoxide in the Presence of a Slight Excess of CO₂

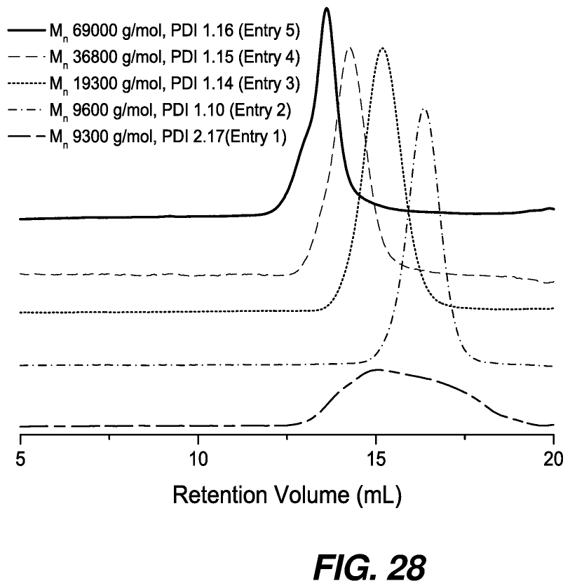

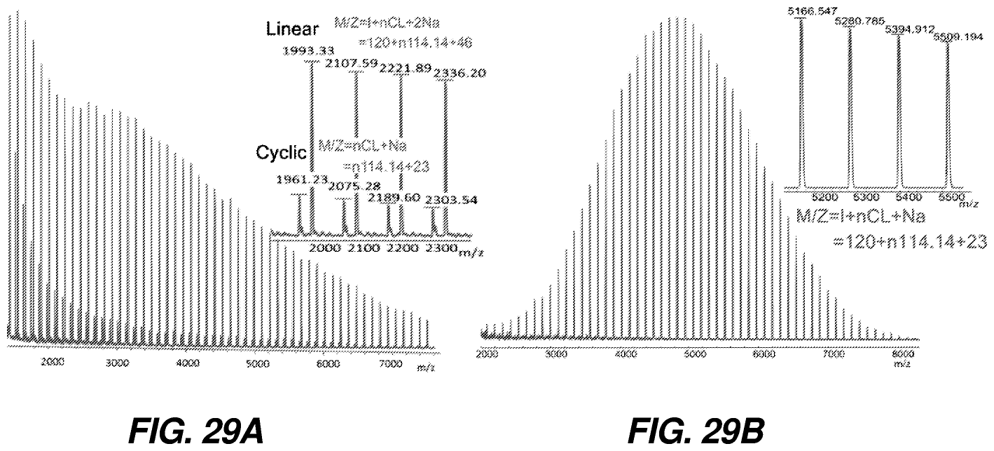

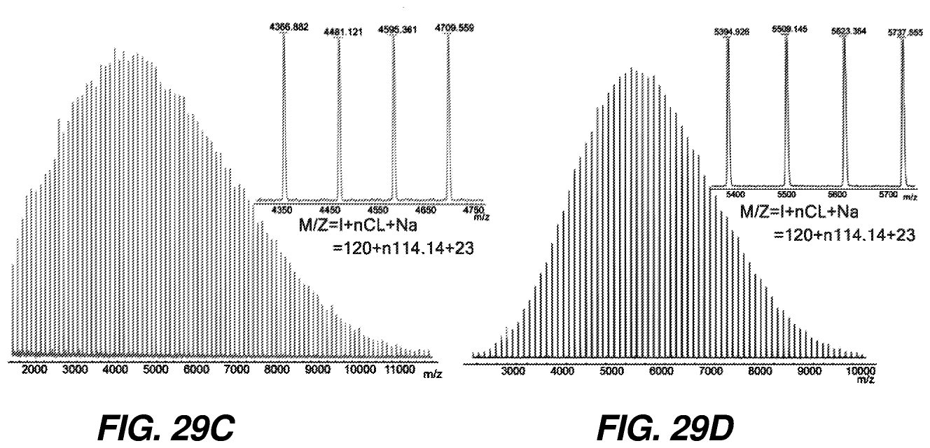

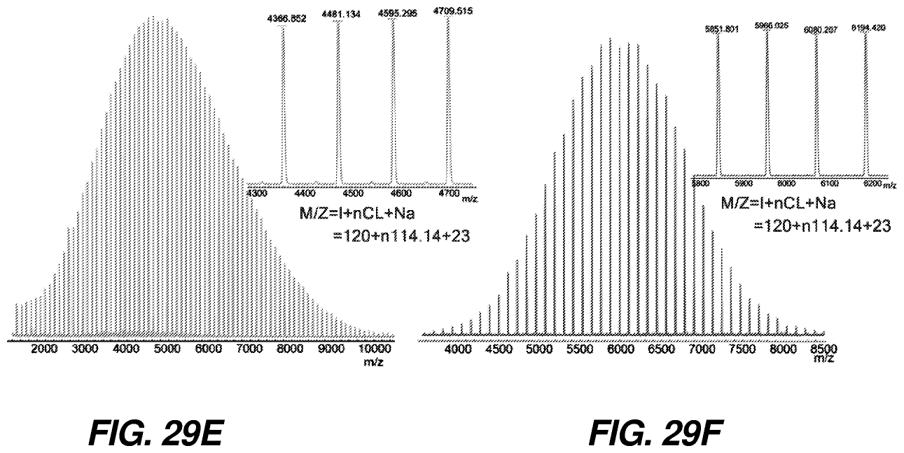

Based on recent reports, it appears that the ROP of cyclic esters can be totally quenched in the presence of a high pressure CO₂ and resumed upon removal of the latter, indicating that carbonates and alkoxides could be generated back and forth by mere application or release of a CO₂ overpressure. The initiating species used, DBU-alkoxide in the first case and dizinc complex in the second, bring about a controlled polymerization of cyclic esters in absence of CO₂. However, with alkali alkoxides it is not the case. As described in the literature, conventional anionic ROP of ε-caprolactone by alkali alkoxides is known to be crippled by strong transesterifications which results in a broadening of the sample molar mass distribution and in the loss of its chain end functionality. To test the effect of CO₂ on the course of polymerization, diethylene glycol monomethyl ether (MEEOH) was chosen as precursor and deprotonated using BuLi to create a lithium alkoxide as initiator and a lithium carbonate upon introduction of CO₂. The results of controlled experiments carried out in absence of CO₂ are listed in entries 1 and 2 in Table 1, they clearly demonstrate the occurrence of transesterification (FIGS. 28-29), no matter the DP targeted.

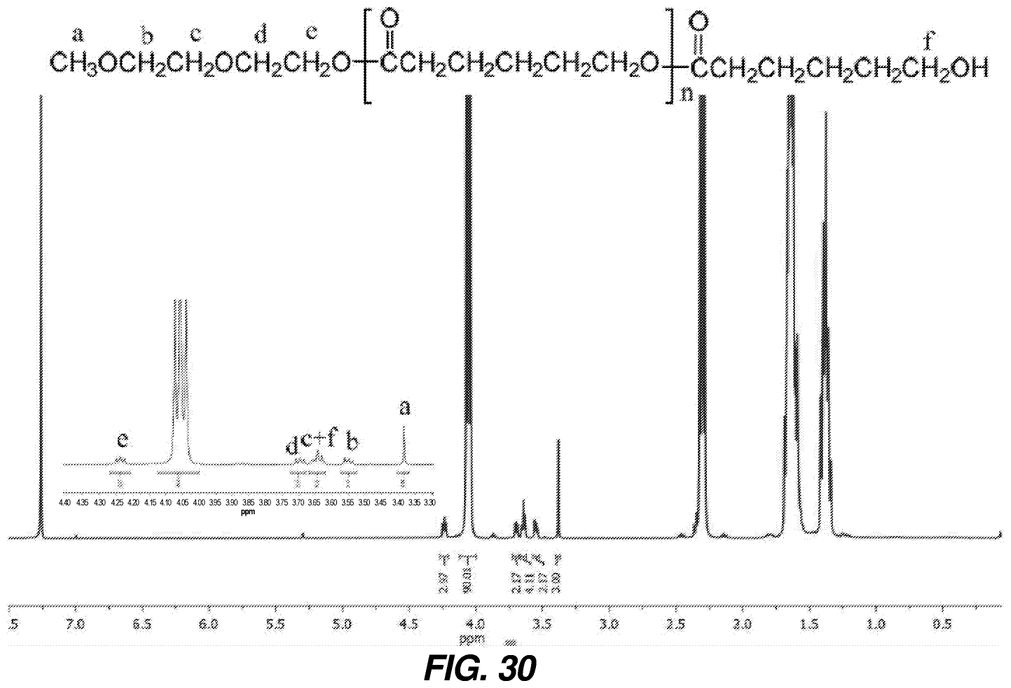

Instead of saturating the reaction medium with CO₂ which is known to totally quench the polymerization, only a slight excess of CO₂ (1.5 eq.) with respect to lithium alkoxide was introduced into the reaction medium. As expected, no polymerization occurred at room temperature under argon unlike the case of the previous controlled experiments, indicating that all initial alkoxides have been transformed into inert carbonates towards ε-caprolactone. However at 100° C., the polymerization, though sluggish, occurred, suggesting that a minute amount of reactive alkoxide is formed and is in fast equilibrium with the lithium carbonate previously generated upon addition of CO₂. Instead of operating under an overpressure of argon, it was chosen to evacuate this inert gas and carried out the polymerization with the same 50% excess of CO₂ with respect to lithium alkoxide. Under these conditions, ε-caprolactone could be polymerized at 70° C. under truly “living” conditions. As seen from the results listed in Table 1 (entry 3-6), after 45 mins to a couple of hours, 90% of conversion of monomer could be reached depending upon the targeted polymerization degrees (50-500 DP). The polymers obtained were subsequently thoroughly characterized. In all cases, the polymer samples obtained exhibit narrow and monomodal distributions (FIG. 28), the GPC molar masses calculated after correction matching well with the expected values deduced from conversion data. The NMR results clearly demonstrate the incorporation of MEEOH initiator moiety (FIG. 30), the initiator methyl groups could be unambiguously detected at 3.38 ppm, and the signal assigned to methylene protons connected to lithium oxide moved to low field at 4.24 ppm after initiation, the terminal methylene protons connected to the hydroxyls appearing at 3.65 ppm, and overlapping with the 6 remaining methylene protons of initiator. The integral ratio of these peaks a, b, (c+f) and d is close to 3:2:4:2, indicating the integrity of the produced α,ω-heterodifunctional polymer. Using the characteristic peaks due to the initiator and taking it as reference, M_{n(NMR)} could be calculated. Again the obtained values matched with those of GPC and the expected ones drawn from conversion. The samples prepared were further characterized by MALDI-ToF. As shown in FIGS. 29A-F, in absence of CO₂, the obtained polymers exhibited a broad and unsymmetrical distribution (FIG. 29A); in addition to a population due to the linear polymer (m/z=MEEOH+n(CL)+2Na⁺=120+114.05 n+2×23), another one assigned to cyclic polymers could also be unambiguously detected, indicating the occurrence of inter- and intramolecular transesterification reaction. On the other hand, in the presence of CO₂, only one narrow and symmetrical population was detected, and the peak to peak mass difference 114 corresponded exactly to the molar mass of ε-caprolactone (FIG. 29B). Indeed all the peaks appeared at m/z=MEEOH+n(CL)+Na⁺=114.05n+120+23. Based on these results, it can be confidently concluded that the ROP of ε-caprolactone proceeded under controlled/living conditions in the presence of a slight excess of CO₂, which happened to prevent both inter- and intra-transesterification reactions.

If a slight excess CO₂ was absolutely necessary to efficiently control the ROP of ε-caprolactone, the use of 2.5 eq. CO₂ versus the Li alkoxide initiator resulted in longer polymerization times to reach the same conversion: the polymerization still occurred under living conditions but at a slower rate indicating that the concentration of species responsible for propagation has decreased (entry 16). In contrast, when the lithium carbonate adduct formed upon reaction of lithium alkoxide with CO₂ was used as initiator with no excess of the latter gas, the PDI of the obtained polymer sample was a little broader in comparison to the one prepared with 1.5 equivalent of CO₂ (entry 17). The existence of transesterification reaction could be clearly demonstrated from MALDI-ToF characterization in the latter case (FIG. 29C). This situation reminds that of the ROP of ε-caprolactone initiated by the carbene-CO₂ adduct, which could control only partially the ROP of cyclic esters. With the same lithium carbonate adduct used as initiator and in the presence of 0.5 equivalent of CO₂, a similar polymerization result was obtained to that initiated with lithium alkoxide and 1.5 eq. CO₂ (entry 18 in Table 1, FIG. 29D). The nature of the solvent used is of utmost importance for the results eventually obtained. When carried out in coordinating solvents such as THF the polymerization was faster, but at the same time some transesterification was also observed. As seen from Table 1 (entry 9-11), the PDI of the polymer produced in THF was broader (1.30), and the molar mass obtained deviated from the expected one, in particular when a high DP was targeted (entry 11). Indeed the MALDI-ToF spectrum of the latter sample showed an unsymmetrical distribution (FIG. 29E). In non-coordinating solvents such as toluene the polymerization occurred under similar conditions to those observed in DCM (entry 13-15 in Table 1). The MALDI-ToF spectrum of the sample prepared in toluene which is shown in FIG. 29F clearly supported the conclusion drawn before as to the absence of any transesterification reaction for samples prepared in DCM. The size of the cation is known to have a strong influence on the rate of the polymerization of ε-caprolactone. Generally bulkier the cation, faster the rate of polymerization due to the higher reactivity of the associated alkoxide. However in the presence of an excess of CO₂, when potassium or imidazolium alkoxide were used as initiator, no polymerization occurred even after 2 or 3 days in apolar media. The latter result suggested that the mechanism of polymerization in the presence of a slight excess of CO₂ was more complicated than initially thought and was certainly not governed by a mere equilibrium between carbonates and alkoxides (see next section where this point is discussed further).

The behavior of such CO₂-mediated ε-caprolactone polymerization beyond 90% and full conversion was also investigated. As shown in entry 8 in Table 1, beyond 90% and as polymerization neared completion and full monomer conversion, the polymer sample exhibited a broader distribution of molar masses. On the other hand, the “living” nature of the polymerization in the presence of 1.5 eq. of CO₂ could be confirmed again (entry 7 in Table 1) through the addition of a second quantity of monomer before its full conversion from the first addition. As seen from entry 7 in Table 1, the molar masses of polymer eventually obtained continued to increase after the second addition of monomer and the PDI remained narrow. Such chain extension experiment demonstrated that such CO₂-mediated ROP of ε-caprolactone retained its “living” character and survived after a second monomer addition.

### ROP of L-Lactide by Lithium Alkoxide in the Presence of a Slight Excess of CO₂

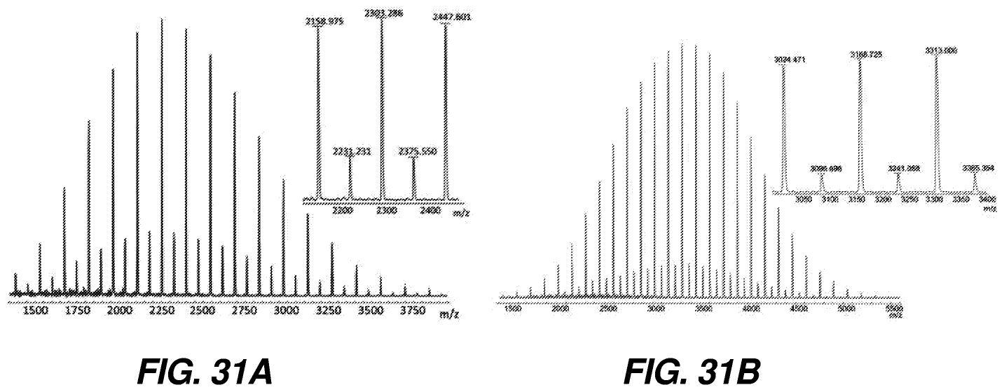

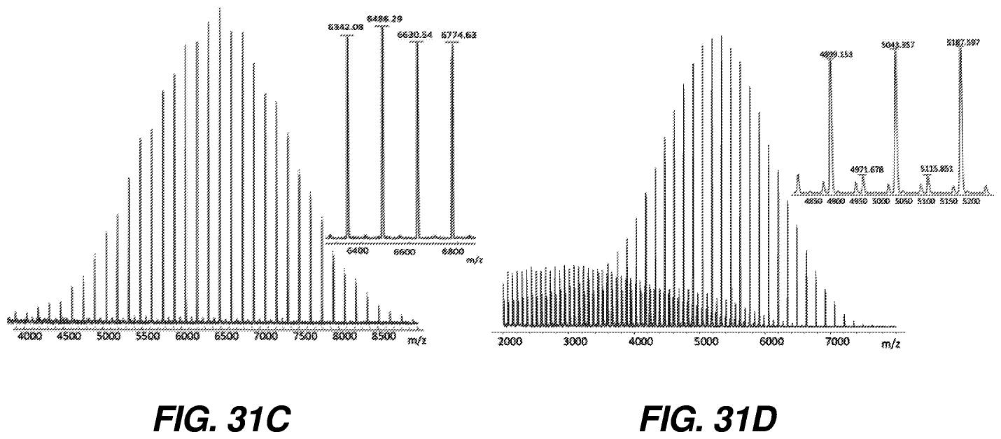

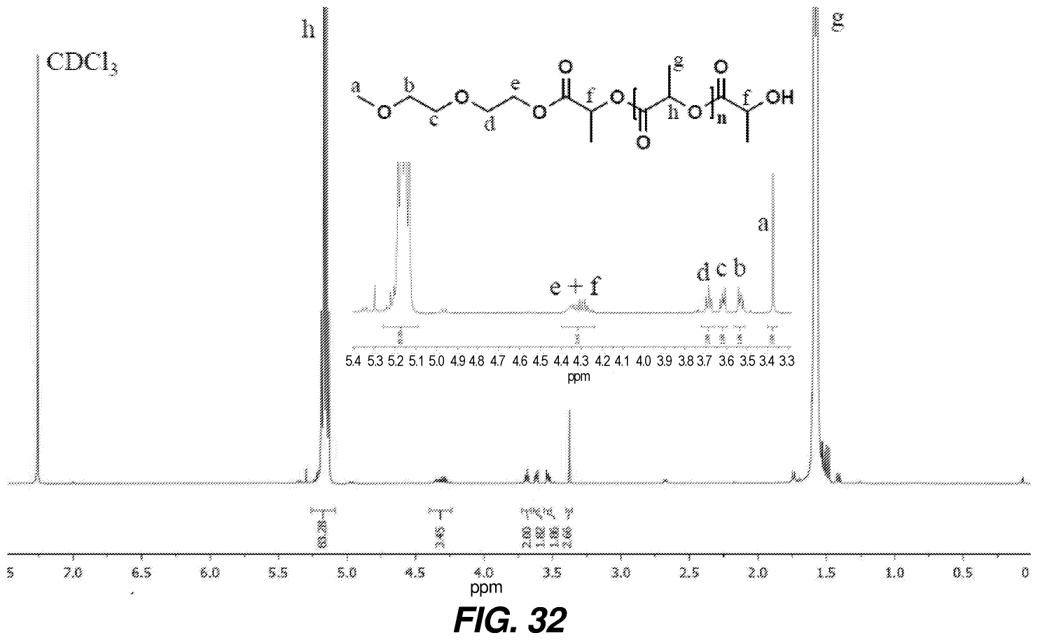

The same strategy was applied for the polymerization of L-lactide. In the latter case, secondary alkoxides were responsible for the ring opening, which made the polymerization occur faster and thus more difficult to control. At 50° C. in the presence of 3 eq. of CO₂ with respect to lithium alkoxide, polymerization occurred; under similar conditions, the polymerization of ε-caprolactone would have been much slower. Although the distribution of molar mass of the sample obtained looks narrow and molar mass values appear close to the expected ones (entry 22, Table 1), transesterification could be clearly seen in the MALDI-ToF spectrum. As shown in FIG. 31A, besides the main population with an even number of repeating units of lactide, another population with an odd number units was detected, indicating the occurrence of transesterification during polymerization. Upon lowering the temperature of polymerization, these side reactions could effectively be suppressed. At −20° C., transesterification became negligible (entry 24, Table 1), and only one population with even number of lactide units was detected (FIG. 31C, 32). In absence of CO₂ and at −20° C., transesterification occurred to a detectable extent, which confirmed the role played by CO₂ in the control of polymerization. Indeed, as shown in FIG. 31D, a multimodal distribution with more than one was detected by MALDI-ToF analysis for the sample prepared at −20° C. in absence of CO₂. The results of the present investigation may be used to investigate experimental conditions that would be favorable for the synthesis of PLLA samples of higher DP and of higher conversion.

### Mechanistic Study

Under conventional AROP as shown in Scheme 1, both propagation and inter- and intramolecular transesterification reactions occur concomitantly during the course of polymerization. To favor propagation over transesterification (r=kₚ/kₜᵣ), there are two options: either selectively activate the monomer or engineer the structure of the growing active species and their activity so as to dramatically increase r: the ratio of the rate constant of propagation to that of transesterification. In this investigation, it is clear that the active species responsible for the propagation was lithium alkoxide as the structure of the polymer formed was exactly that of polymers obtained with classical initiators. As a consequence, CO₂ was not incorporated in the growing polymer which therefore suggested that the role of CO₂ was uniquely to trap the growing alkoxide and generate dormant carbonates that are unable to ROP cyclic esters. It was therefore tempting to conclude that in the presence of CO₂, an overwhelming proportion of growing alkoxides was transformed into inactive carbonates, leaving a minute amount of alkoxides in dynamic equilibrium with carbonate and whose concentration can vary with the temperature. However experiments carried out with very low concentration of alkoxides revealed the occurrence of transesterification reactions and a significant broadening of the molar mass distribution (entry 2 in Table 1). In other words, lithium alkoxides were responsible for propagation, but existed in the presence of CO₂ in a form that prevented their involvement in transesterification. Therefore, an equilibrium such as the one shown below cannot describe the reality actually observed.

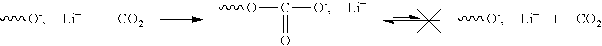

Confronted to this enigma, NMR characterization of the species formed in the reaction medium and to DFT studies were used to better account for experimental results.

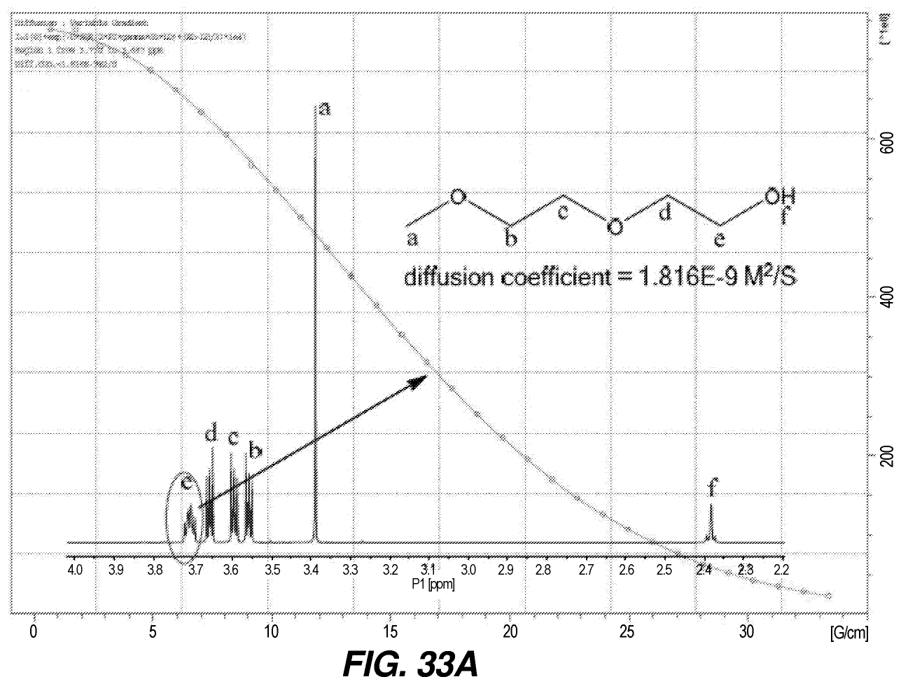

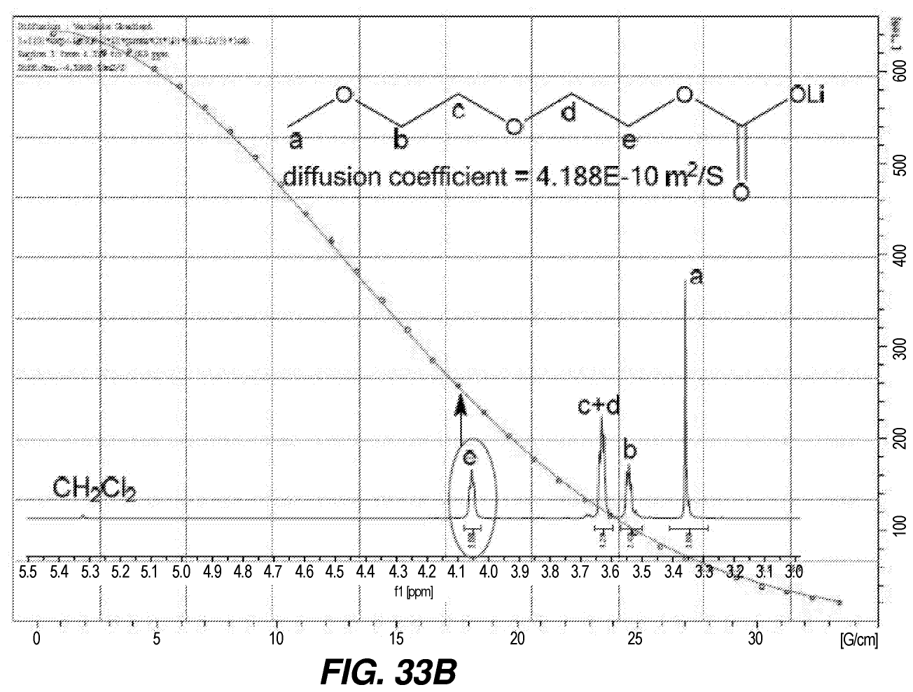

Lithium alkoxides (MEEOLi) may form tetrameric aggregates in apolar solvents; to deduce the aggregation number of the corresponding lithium carbonate (MEEOCO₂Li), pulsed-field-gradient (PFG) NMR experiments were conducted to determine their diffusion rate and compare it with that of the alcohol precursor (MEEOH). As shown in FIG. 33, the ratio of 4.3 between the diffusion coefficients of the two species indicated that MEEOCO₂Li formed tetrameric aggregates like MEEOLi, assuming MEEOH was monomeric.

DFT analysis was performed and, for the efficiency of the calculation, lithium methoxide (MeOLi) was used as the model representing lithium alkoxide and ethyl acetate (AcOEt) was chosen to simulate the reactivity exhibited by the linear ester chains. All the structures were fully optimized at the M06/6-311G(d,p) level of theory with the Gaussian09 package. Single point energy calculations were refined at M06/6-311+G(d,p) with DCM solvation effects from IEF-PCM model to provide more reliability to the computed energies. In order to obtain more accurate entropic contributions, the Gibbs free energies were corrected. Accordingly, a reaction changing from m- to n-components had an additional correction to the Gibbs free energies of (n−m)×4.3 kcal/mol.

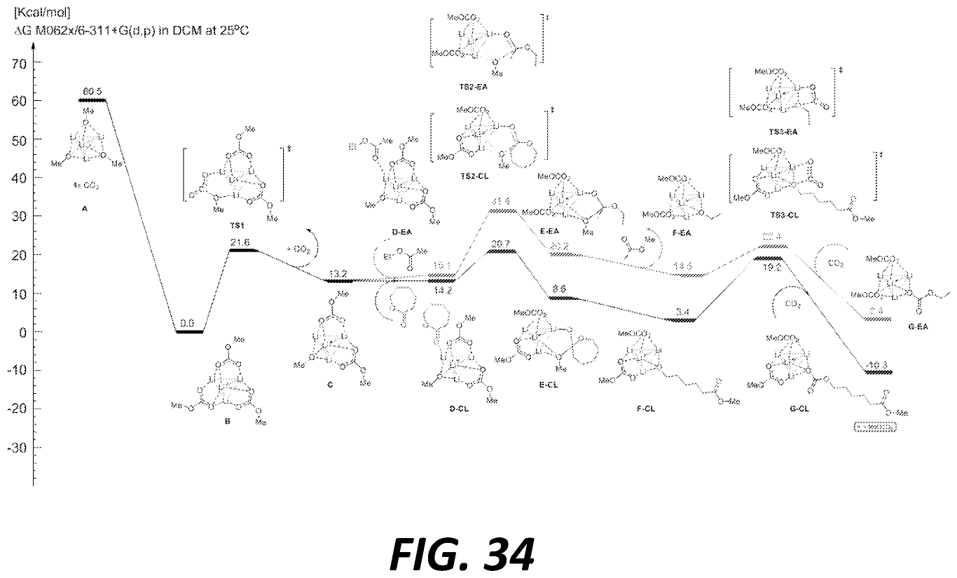

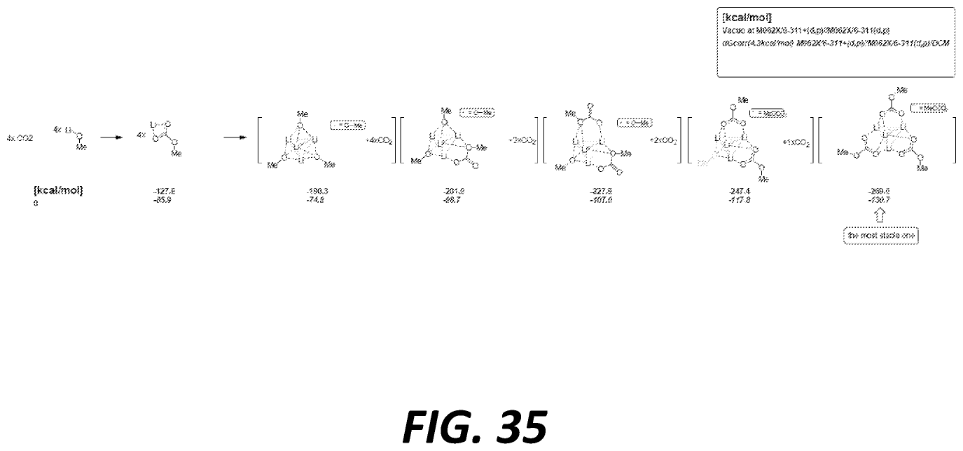

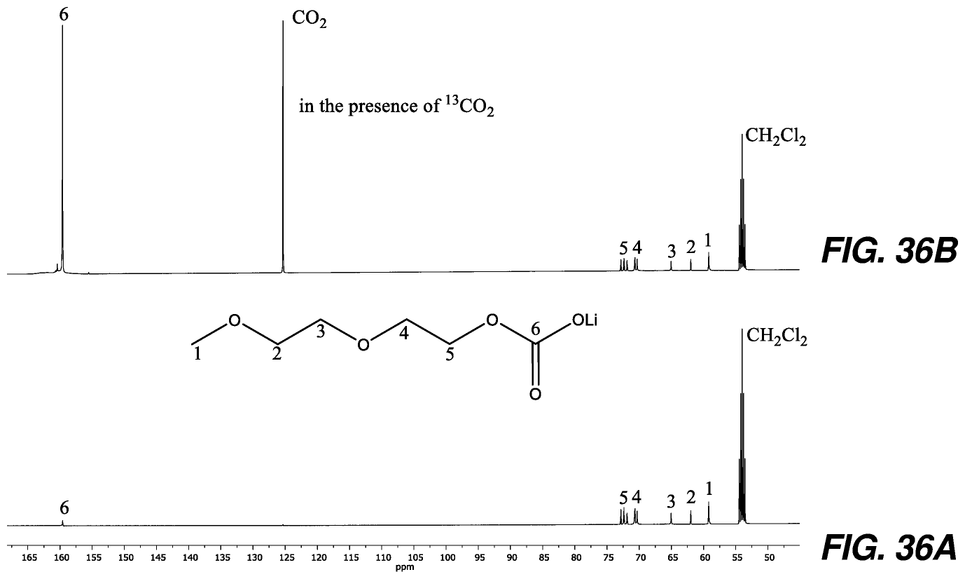

Scheme 2 (shown in FIG. 34) is a free energy reaction profile for the proposed lithium carbonate tetramer with ε-caprolactone (CL) and ethyl acetate (EA) in the presence of CO₂. Tetrameric aggregates of (MeOLi)₄ (Scheme 2, A) formed in the presence of CO₂ and were agreement with PFG NMR observations (FIG. 33) tetrameric carbonates (Scheme 2, B): a stable species found to be the most energetically favorable structure under such experimental conditions (FIG. 35). While it is well known that tetrameric carbonate (B) is not reactive towards transesterification, it was opted to investigate the reactivity of the mixed tetramer made of one alkoxide and three carbonates (Scheme 2, C) obtained upon liberation of one CO₂ (ΔG^{‡}=21.6 kcal/mol). Very interestingly, the alkoxide carried by C was found active and able to open the ring of ε-caprolactone (addition of the monomer) with a relatively low overall activation energy of 20.7 kcal/mol and allowed the growth of polyester chain (Scheme 2, TS2-CL); in contrast, the transesterification with AcOEt appeared kinetically much more difficult with an overall activation energy of 31.4 kcal/mol (Scheme 2, TS2-EA). The reactive alkoxide moiety of the resulting intermediate F-CL appeared then stabilized by a CO₂ molecule to form a new carbonate tetramer (Scheme 2, G-CL). The liberation of CO₂ from one of the carbonate groups can thus occur randomly to allow the chain to grow from another alkoxide end group. To check whether such fast equilibrium and exchange really occurred between B and C, F-CL and G-CL as shown in Scheme 2, a NMR experiment was performed whose aim was to explore lithium carbonate in the presence of CO₂, and the results of this characterization is shown in FIG. 36. After keeping the sample for 2 hrs at 70° C., the intensity of the peak at 159.6 ppm assigned to carbonate carbon increased remarkably, whereas the relative intensity of other peaks remained unchanged, confirming that the previously expected exchange of CO₂ actually occurred.

Scheme 3 is a proposed mechanism of AROP of ε-caprolactone initiated by lithium alkoxide or carbonate through the mediation of CO₂:

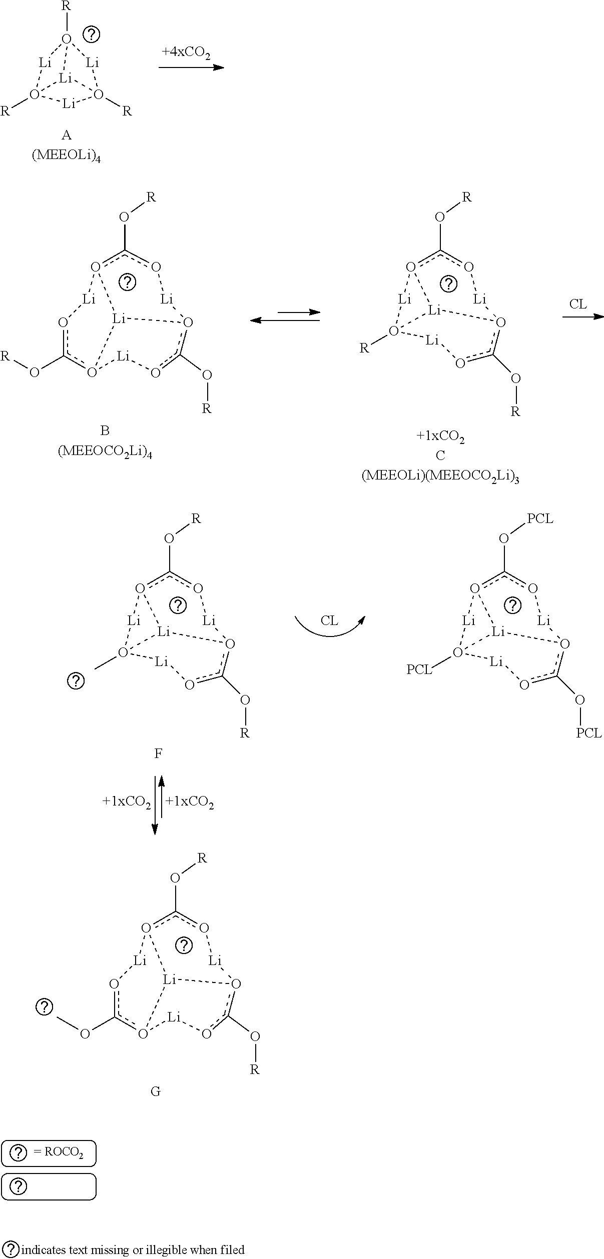

Based on these calculations and the experimental results obtained, a polymerization mechanism was proposed in Scheme 3. The pre-prepared or in situ formed lithium carbonates aggregated into tetrameric species B; upon removing the overpressure of argon or upon heating, one molecule of CO₂ was liberated to produce a mixed alkoxide-carbonate C, which was able to initiate the ring opening polymerization of cyclic esters. In the presence of an excess of CO₂ in the reaction media, growing lithium alkoxides quickly underwent carbonation by CO₂ and were transformed into carbonate tetramer aggregate G as dormant species. Due to fast CO₂ liberation and concomitant carbonate formation, all the lithium carbonates exhibited the same reactivity and participated in the polymerization. From the calculation results that establish the energy profile, C and F selectively and preferably attacked the monomer rather than the polyester chains for transesterification.

In summary, this Example demonstrated for the first time a new role for CO₂ which could be utilized to control the polymerization of cyclic esters. In-situ formed or purposely prepared lithium carbonate could initiate the polymerization of ε-caprolactone or L-lactide and allow polymer chains to grow under “living” conditions in aploar solvents such as toluene and DCM; the polymerization was indeed well controlled and transesterification was effectively suppressed in the presence of slight excess of CO₂. Mechanistic study and DFT calculation unveiled the existence of a fast equilibrium between 2 tetrameric species, one comprising exclusively lithium carbonates the second including and mixed lithium alkoxide-carbonate [(ROLi)(RCO₃Li)₃]. This equilibrium was the key to control the AROP of cyclic esters, where the former acted as the dormant species, and the latter as the active species. The high selectivity of the chain propagation over transesterification was corroborated by the energy preferred of the attack of the monomer (20.7 kcal/mol) over that of the polymer chain (31.4 kcal/mol). This method, which relied on lithium initiators regularly used in anionic polymerization, avoided resort to complexed initiators or monomer activators and proved to be a very simple way to synthesize polyesters in particular for biomedical applications.

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto

Various examples have been described. These and other examples are within the scope of the following claims.

What is claimed is:

1. A method of making a polyester compound, comprising:
adding an initiator and a non-coordinating solvent to a reaction medium, wherein the initiator is a lithium alkoxide;
charging the reaction medium with an amount of carbon dioxide to suppress transesterification reactions; and
adding a cyclic ester compound to the reaction medium, wherein the cyclic ester compound is polymerized to form the polyester compound.

2. The method of claim 1, wherein the non-coordinating solvent is one or more of dichloromethane, toluene, and benzene.

3. The method of claim 1, wherein an excess of carbon dioxide relative to the initiator is charged to the reaction vessel.

4. The method of claim 1, wherein about 0.5 to about 3 equivalents of carbon dioxide relative to the initiator is charged to the reaction medium.

5. The method of claim 1, wherein the charging results in an equilibrium between an active species and dormant species.

6. The method of claim 5, wherein the dormant species is present in an amount greater than the active species.

7. The method of claim 5, wherein the dormant species is a carbonate species.

8. The method of claim 5, wherein the active species is an alkoxide-carbonate species.

9. The method of claim 1, wherein a level of transesterification is undetectable.

10. The method of claim 1, wherein transesterification includes intermolecular transesterification.

11. The method of claim 1, wherein transesterification includes intramolecular transesterification.

12. The method of claim 1, wherein the cyclic ester compound is one or more of acetolactone, propiolactone, butyrolactone, valerolactone, and caprolactone.

13. The method of claim 1, wherein the cyclic ester compound is one or more of ε-caprolactone, L-Lactide, β-propiolactone.

14. The method of claim 1, wherein a temperature of the reaction medium during polymerization ranges from about −20° C. to about 70° C.

15. The method of claim 1, wherein the polyester compound has a polydispersity index ranging from about 1 to about 2.
